(19) United States
(12) Patent Application Publication
(10) Pub. No.: US 2023/0408380 A1
(43) Pub. Date: Dec. 21, 2023

(54) AIR MONITORING SYSTEMS AND METHODS

(71) Applicant: U-EARTH BIOTECH LTD, London (GB)

(72) Inventor: Elisabetta MAGGIO, Milano (MI) (IT)

(73) Assignee: U-EARTH BIOTECH LTD, London (GB)

(21) Appl. No.: 18/252,560

(22) PCT Filed: Nov. 16, 2021
(86) PCT No.: PCT/EP2021/081885

§ 371 Date: May 11, 2023

(30) Foreign Application Priority Data
Nov. 16, 2020 (IT) 102020000027381

(51) Int. Cl. G01N 1/22; F24F 8/125; F24F 8/133

(52) U.S. Cl. CPC G01N 1/2273; G01N 1/2205; F24F 8/125; F24F 8/133; F24F 2110/10

(57) ABSTRACT

An air monitoring system having a device which captures air contaminants, particularly biological particles, particularly viruses, more particularly SARS-CoV-2 is provided, and to methods associated with the system for sampling and detecting them in the air but also for digesting the captured biological particles by bio-oxidation through a microorganism compound additive. The invention also relates to kits of parts having the device and at least a test, preferably an antigen test cassette as well as to their use in detecting said biological particles within the air.

### FIELD OF THE INVENTION

The invention relates generally to air monitoring systems and methods, in particular to systems and methods for sampling and detecting biological particles in the air. The invention also relates to kits of parts comprising said systems as well as to their use in detecting said biological particles within the air.

### BACKGROUND OF THE INVENTION

Currently, our response to infectious disease outbreaks, in particular that by Severe Acute Respiratory Syndrome Coronavirus 2 (SARS-CoV-2), a strain of coronaviruses that causes COVID-19, mainly depends on patient testing, e.g. through blood and swab sampling, by means of molecular tests, such as RT-PCR tests, that detect the virus's genetic material, antigen tests that detect specific proteins on the surface of the virus and/or antibody tests that look for antibodies to the virus. However, in doing so, the disease is detected only after an outbreak has already occurred with consequences that, depending on the severity of the disease, can be as serious as a pandemic. This was the case in December 2019, when SARS-CoV-2 spread and caused the COVID-19 health emergency outbreak, a pandemic affecting more than 51.5 million people, with more than 1.3 million deaths in 231 countries.

Therefore, it would be desirable to provide systems and methods not relying on patient testing and able to identify potential outbreaks well before they actually occur, thus functioning as preventive surveillance systems.

Since it is generally known that biological particles can disperse into the air through dust and water drops and that (pathogenic) microorganisms such as algae, protozoa, yeasts, molds, and viruses (including influenza, SARS, Mycobacterium tuberculosis, Foot-and-mouth disease and many others) have been isolated from air samples and could be transmittable over long distances, the inventors of the present invention thought that air monitoring could be used as an early detection and warning system for infectious disease outbreaks.

An up to date 2020 study provided evidence that also SARS-CoV-2 is widely distributed in the air, and the air transmission distance thereof might reach up to 4 meters (Guo Z., Wang Z., Zhang S., et al.: Aerosol and surface distribution of severe acute respiratory syndrome coronavirus 2 in hospital wards, Wuhan, China, 2020. Emerg. Infect. Dis. 2020; 26(7):1583-1591. DOI: 10.3201/eid2607.200885).

Also known in the art are various air or aerosol sampling systems such as, for example, direct impaction of air onto agar, or other solid phase surfaces, direct filtration such as Surface Air Systems (SAS), samplers equipped with filters as polytetrafluoroethylene (PTFE), polycarbonate (PC), cellulose or gelatin filers, samplers such as the Anderson's impactor and centrifugal collection such as the Reuter Centrifugal System (RCS). However, most of these sampling systems are not suited for the analysis (recovering, quantifying and/or identifying) of biological particles or bioaerosols mostly because they cannot reliably preserve their viability or their genetic materials as they exist suspended in air. All of these samplers, in particular filter-based methods, in fact can be very destructive for biological particles, especially viruses. For instance, filters impart intense mechanical stress and desiccation on bioaerosols, and samples elution is needed for further processing drastically affecting sensitivity of the analysis (e.g. PCR or sequencing). Moreover, impactors or impingers might not be applicable for sampling biological particles as small as viruses because their collection efficacy decreases as particle size decreases. In addition, to the best of the inventors' knowledge, none of these systems has proved to be effective and reliable in the sampling and/or detection of coronaviruses such as SARS-CoV-2.

Another limit of the air or aerosol sampling systems known in the art is the fact that, after sampling or detection, they cannot be used to destroy potentially harmful biological particles and so must be treated or disposed of as hazardous.

Therefore, since existing systems and methods for air or aerosol sampling and/or collection are not suited for biological particles and might affect the quantitative and qualitative data that can be drawn from them after processing, there is still the need for improved air monitoring systems and methods, in particular for sampling and/or detection of biological particles, particularly viruses, more particularly SARS-CoV-2, in the air.

Another very recent study (Lednicky J. A., Lauzardo M., Fan Z. H., et al.: Viable SARS-CoV-2 in the air of a hospital room with COVID-19 patients. Int. J. Infect. Dis. 2020; 100: 476-482. DOI: https://doi.org/10.1016/j.ijid.2020.09.025) showed in fact how patients with respiratory manifestations of COVID-19 produce aerosols which serve as a source of transmission of the virus, posing once again great attention to the quality of air. Therefore, it would be also desirable to provide systems and methods, apt not only to sample and detect biological particles in the air, but also to disactivate and/or digest and/or destroy them before recirculating the air in the environment.

### Glossary

Terms used in the context of the present description have to be construed as commonly understood by a person skilled in the art relevant to the invention, unless indicated otherwise.

In the context of the present description, the terms “biological particles”, “bioaerosols” and “primary biological aerosol particles” (PBAPs) are used interchangeably to describe solid airborne particles derived from biological organisms, including microorganisms and fragments of biological materials bacteria. These terms thus can refer to any airborne compound of biological origin such as, for example, any intact airborne cells, their airborne component parts and/or dissociated airborne genetic materials including bacterial cells and spores, viruses, pollen, fungi, algae, detritus, allergens, protozoa, parasites and microorganisms in general, and other particles of biological origin and/or cell fragments including nucleic acids, proteins and toxins.

Therefore, according to the present description, the terms “biological particles”, “bioaerosols” or “PBAPs”, whit reference to any one of the embodiment of the present invention, can also be construed as indicating one or more of the following: bacterial cells and spores, viruses, pollen, fungi, algae, detritus, allergens, protozoa, parasites, and/or cell fragments including nucleic acids, proteins and toxins, wherein said viruses are preferably coronaviruses, beta-coronaviruses, SARS-CoV-2; Influenza A virus (FLU A), Influenza A virus subtype H1 (Flu A-H1 or Flu A-H1pdm09 or swine influenza), Influenza A virus subtype H3 (Flu A-H3); Influenza B virus (FLU B); Respiratory syncytial virus type A (RSV A) or type B (RSV B); Adenovirus (ADV); Enterovirus (HEV); Parainfluenza virus 1, 2, 3, or 4 (PV1, PV2, PV3, PV4) and/or Metapneumovirus (PMV).

Sometimes these terms are also used to include secondary particles in the atmosphere that are formed from the condensation of gaseous molecules released by biological organisms. As known, bioaerosols are a means for transmission of diseases between humans, crops and livestock. They can cause allergic reactions and affect indoor air quality too.

The term “biosensor” in the context of the present description is construed as generally known in the art. Briefly, a biosensor is a device that measures biological or chemical reactions by generating detectable signals which are usually proportional to the concentration of an analyte in the reaction. A typical biosensor comprises the following components: a bioreceptor that is a molecule (e.g. enzymes, cells, aptamers, deoxyribonucleic acid (DNA) and antibodies) that specifically recognises the analyte of interest and can generate a signal (in the form of light, heat, pH, charge or mass change, etc.) upon interaction of the bioreceptor with the analyte; a transducer, an element that converts the bio-recognition event into a measurable and detectable signal (e.g. optical or electrical), electronics, which can comprise electronic circuitry that performs signal conditioning such as amplification and conversion of signals from analogue into the digital form, configured to process the transduced signal preparing it for display and a display unit which can consist of a user interpretation system such as the liquid crystal display of a computer or a direct printer that generates numbers or curves understandable by the user. This part often consists of a combination of hardware and software that generates results of the biosensor in a user-friendly manner. The output signal on the display can be numeric, graphic, tabular or an image, depending on the requirements of the end user (see also Essays Biochem. 2016 Jun. 30; 60(1): 1-8, published online 2016 Jun. 30. doi: 10.1042/EBC20150001).

The wording “comprising certain features” is interpreted as meaning that the device/kit of parts/method/product includes those features, but that it does not exclude the presence of other features, while if the wording “consist of certain features” is used, then no further features are present in the device/kit of parts/method/product apart from the ones following said wording. In the context of the present description however, the term “comprising” can be also construed as meaning “consisting of”.

### SUMMARY OF THE INVENTION

With the aim of identifying potential outbreaks and/or provide a prompter response to infectious disease outbreaks, the inventors of the present invention, after extensive experimentation, found out that a device such as the one disclosed in International Patent Application No PCT/US2019/016440, can be advantageously used as a biological particles or (bio)aerosols sampling and/or detecting system and developed an air monitoring system and method able to overcome the drawbacks of those already known in the art.

To this end, during the recent health emergency from SARS-CoV-2, devices such as the ones disclosed in International Patent Application No PCT/US2019/016440, were installed in some health facilities in Milan to treat the indoor air of the spaces adjacent to their positioning, and in particular in the so-called “COVID-19” departments. Besides confirming their air purification function, said devices, as will be apparent from the following detailed description and examples, proved to be effective air biomonitoring systems, particularly with reference to biological particles and bioaerosols more particularly with reference to viruses.

Therefore, the present invention refers to the use of the device better described in the following detailed description, or according to any of the embodiments disclosed in the International Patent Application No PCT/US2019/016440, for detecting and/or monitoring the presence of biological particles in the air particularly by testing the liquid of one or more collecting means of said device and/or the inlet air of said device.

The present invention also refers to a method for detecting and/or monitoring the presence of biological particles in the air, the method comprising the following steps:
providing a device as described in the following detailed description, or a device according to any of the embodiments disclosed in the International Patent Application No PCT/US2019/016440;
optionally collecting a sample of liquid from one or more collecting means of said device; and
testing said sample of liquid for the presence of one or more biological particles.

As will be apparent from the following detailed description, testing can be carried out in situ and/or demanded to dedicated laboratories according to any of the methods known in the art as suitable for the qualitative and/or quantitative analysis of biological samples such as, but not limited to, PCR-based assays, nucleic acid sequencing, protein expression assays, immunoassays or chromatographic, in vivo or in vitro, bioassays.

However, in cases where a prompt response is of outmost importance, for example during a pandemic, rapid tests such as those known in the art as rapid test cassettes, are preferred.

Therefore, the present invention also refers to kit of parts comprising a device as defined in the following detailed description, or according to any of the embodiments disclosed in the International Patent Application No PCT/US2019/016440, and a test configured to detect the presence of one or more biological particles, wherein said test is preferably a test cassette, more preferably an antigen test cassette, still more preferably an immunochromatographic test cassette or lateral-flow cassette.

The kits of parts according to any embodiment of the present invention can also comprise means configured to collect a sample of liquid from said device, such as for example, but not limited to: pipette, air displacement pipettes, electronic pipette, positive displacement pipette, volumetric pipettes, graduated pipettes, Pasteur pipette and the like.

The invention also refers to the use of an antigen test cassette, preferably an immunochromatographic test cassette or lateral-flow cassette, more preferably an IgA and/or IgM and/or IgG test cassette, for detecting the presence of biological particles within the liquid of one or more collecting means of a device as defined in the following detailed description or according to any of the embodiments disclosed in the International Patent Application No PCT/US2019/016440.

Moreover, another effective way to test the liquid and/or air within said device is by means of biosensor(s).

Therefore, the present invention also refers to a method for detecting and/or monitoring the presence of biological particles in the air, the method comprising the following steps:
providing a device as described in the following detailed description, or a device according to any of the embodiments disclosed in the International Patent Application No PCT/US2019/016440; and
testing a sample of liquid from the collecting means of said device for the presence of one or more biological particles
   preferably wherein the collecting means of said device are equipped with one or more biosensor(s) and wherein said testing is carried out by contacting the sample of liquid with said one or more biosensor(s).

Although the air monitoring system and methods of the present invention cannot specifically identify which individuals have been infected, they have several advantages compared to patient testing. For instance, biological particles, such as those of SARS-CoV-2, can be detected in the air a few days to weeks before the onset of symptoms in patients and so predict infectious outbreaks even before individual patient testing and hospital admissions; one air sample can provide population-wide data on the average infection rate of thousands of people; continual monitoring of air can be used to establish trends in current outbreaks, identify new outbreaks and prevalence of infections. Air surveillance or air monitoring for biological particles, especially for COVID-19, through the systems and methods of the present invention, it's also a cost-effective way to survey transmission dynamics of entire communities; to collect data from people who lacks access to healthcare, to provide near-real-time information on disease prevalence; and to detect the presence of an infection even in the case of asymptomatic patients, which are the majority in the case of COVID-19; it can also facilitate social distancing interventions before community transmission reaches exponential growth and prevent the spread of diseases if people are treated, for example vaccinated, before an outbreak occurs.

Another benefit of air monitoring biological particles through the systems and methods of the present invention, is that it lacks the biases of the traditional indicators used to understand where the disease transmission is occurring, increasing, or decreasing. For instance, in the early days of COVID-19 pandemic, a key indicator was the cumulative number of diagnosed cases, later more attention was given to hospitalizations, deaths, rates of test positivity and serological data. However, these indicators are biased, for example, because the number of cases depends on access to diagnostics, hospitalizations and death lag transmission by weeks, and the rates of test positivity depend on testing regiments protocols and availability. These biases are absent when relying on air surveillance through the systems and methods of the present invention.

Even if is already known in the art that the device described in the International Patent Application No PCT/US2019/016440 can be used as air purification system, to the best of the inventor's knowledge, it has never been shown that it can also be effective in digesting and/or destroying viruses such as, for example, coronaviruses. Now the inventors have surprisingly found that said device is effective not only in detecting but also in digesting and/or destroying viruses such as, but not limited to, coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus.

Therefore, the present invention also relates to the use of the device as disclosed in the following detailed description, or according to any of the embodiments disclosed in the International Patent Application No PCT/US2019/016440, and/or of the kit of parts according to any of the embodiments of the present invention, for purifying the air from biological particles, preferably viruses such as, but not limited to, coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus, more preferably SARS-CoV-2 as well as Volatile Organic Compounds (VOC), dust, allergens, and other inorganic substances included in the atmosphere, thus allowing for recirculation of air free of biological particles and other pollutants, in particular free of coronaviruses, e.g. SARS-CoV-2.

Other advantages, aspects, and features of the present invention will become more apparent from consideration of the following drawings and accompanying detailed description and examples. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

FIGS. 1A-1C show a top view (FIG. 1A), a side view (FIG. 1B), and a perspective view (FIG. 1C) of a Biotech Air Purifier of an embodiment of the present invention.

FIGS. 2A-2B show internal views of parts of the bio support filter and tank of FIG. 1.

FIGS. 3A-3D show internal details of the bio support filter and tank of FIG. 1.

FIG. 4 is top view of concentric circles Bio Support Shape of an embodiment of the present invention.

FIG. 5 is a top view of Multilayer Vertical Bio Support Shape of an embodiment of the present invention.

FIG. 6 is a top view of Corkscrew Bio Support Shape of an embodiment of the present invention.

FIG. 7 shows perspective views of Biotech Air Purifier model range of embodiments of the present invention.

FIG. 8 is a system overview of an embodiment of the present invention.

FIGS. 9A-9B are a front view (FIG. 9A) and a side view (FIG. 9B) of an Air Quality Monitoring System of an embodiment of the present invention.

FIG. 10 shows charts and system architecture of Air monitoring system details of an embodiment of the present invention.

FIG. 11 is a photograph of an internal configuration of the filter of an embodiment of the invention.

FIG. 12 is top view of concentric circles Bio Support Shape of FIG. 4 showing direction of airflow.

FIG. 13 is a chart of a pollution index.

FIG. 14 is a chart of real time air quality data.

FIGS. 15-16 are photographs of a software application that works with the system.

FIG. 17A shows a device equipped with an inlet port and an outlet port for an air flow to be monitored and implementing a method for detecting and/or monitoring the presence of biological particles in the air according to the present invention. Said inlet and outer ports can be equipped with one or more biosensor(s) (not shown).

FIG. 17B shows an air purified device as described in PCT/US2019/016440 implementing a method for detecting and/or monitoring the presence of biological particles in the air according to one embodiment of the present invention.

FIG. 18 is a schematic representation of the distribution of the devices into a highly frequented hospital area of 1000 sqm with a turnover of about 1300 people per day.

FIG. 19 is a photograph of Petri Plates filled with Standard Plate Count Agar (PCA).

FIGS. 20A-20C are charts of the particles count results showing remarkable reductions in the number of particles per cubic meter depending on their particle size.

FIGS. 21A-21B show the results of the rapid tests cassette.

This disclosure will now provide a more detailed and specific description that will make reference to the accompanying drawings. The drawings and specific descriptions of the drawings, as well as any specific or alternative embodiments discussed, are intended to be read in conjunction with the entirety of this disclosure.

### DETAILED DESCRIPTION OF THE INVENTION

### The Device as Disclosed in PCT/US2019/016440

The content of the International Patent Application No PCT/US2019/016440, is incorporated herein by reference. Therefore, even if the main features of the device are as reported below, any embodiment disclosed in said application is encompassed by the present description.

Generally speaking, PCT/US2019/016440 discloses a biological air purifier, which captures air contaminants without limit of size and type by “electric molecular charge attraction” and then digests the captured contaminants by bio-oxidation by means of a microorganism compound additive. The device advantageously also includes air quality monitoring means for assessing the quality of air purified by the device and calculating related destruction rate expressed as a “Pure Air Index”. The collected data can be conveniently transferred to a cloud, and then to a dedicated software for analysis. The air quality monitoring allows broadcasting, in real time, several air quality parameters. For example, different contaminants can be separately detected with sensors such as, but not limited to, a humidity sensor, a temperature sensor, and odorous gas sensor, a carbon monoxide sensor, a carbon dioxide sensor, a NO2 sensor, a VOC sensor, biosensors, etc.

According to a preferred embodiment, the air purifier device comprises or incorporates an air quality monitoring system that can be operatively connected or equipped with “satellite” devices (e.g. indoor/outdoor, freestanding, submersible and/or mounted on small drones or the like) in order to trace monitoring maps associated with data exchanged with a cloud (IoT).

In certain preferred embodiments, such air quality monitoring system can operate independently by, or be connected to, purification means of the air purifier device.

Preferably, by means of dedicated algorithms supported by a consultation platform, it is possible to provide to the user specific air quality alerts that contribute to guarantee a pure air zone certification.

According to an advantageous aspect of the present invention, a method for detecting and monitoring air quality parameters, in particular the presence of biological particles, is provided.

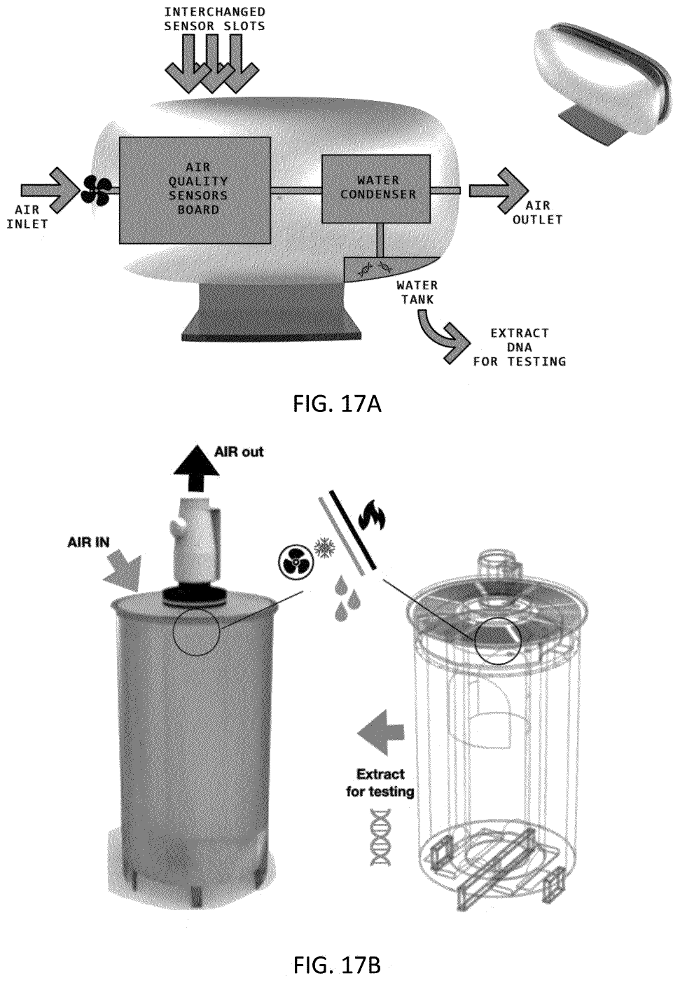

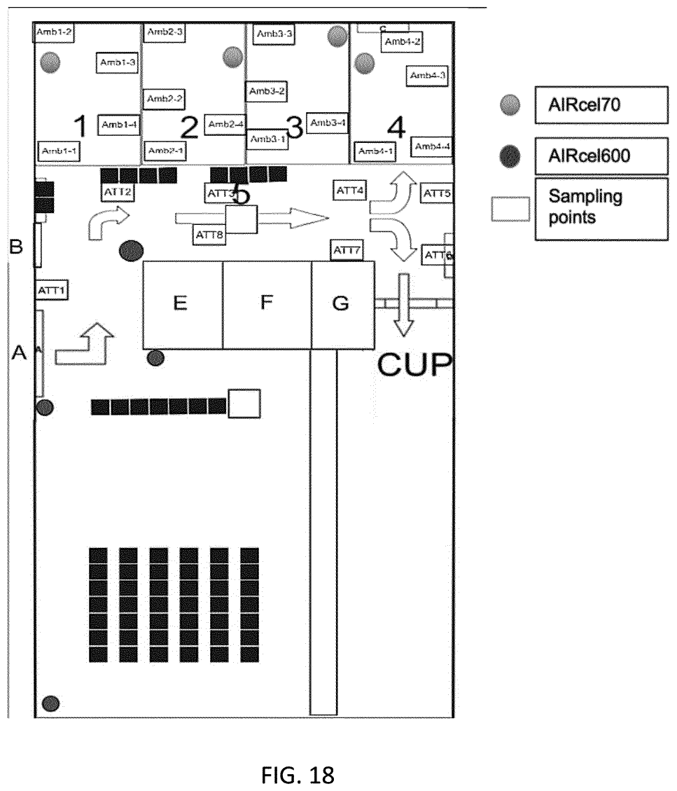

Said method will be illustrated in the rest of the present description, particularly with reference to FIGS. 17A and 17B that show two embodiments incorporating the inventive principle of the present invention.

FIG. 17A shows a device equipped with an inlet port and an outlet port for an air flow to be monitored and implementing a method for detecting and/or monitoring the presence of biological particles in the air according to the present invention. The inlet and/or outlet ports can be equipped with biosensors.

FIG. 17B shows an air purified device as described in PCT/US2019/016440 implementing a method for detecting and/or monitoring the presence of biological particles in the air according to the present invention.

With initial reference to the embodiment of FIG. 17A, the air flow is conveyed inside the device through an air inlet and preferably by means of conveying means, for example a fan.

Said device further comprises condensation means for a sucked air and a tank for collecting the liquid phase of said condensed air.

Preferably, the device also comprises a detection chamber for the sucked air flow. The embodiment shown in FIG. 17A provides for a fluid communication in series between the detection chamber and the tank that is the air flow sucked through the air inlet crosses first the detection chamber and secondly the condensation means, to be expelled from the device by an air outlet.

Alternatively, the order of the detection chamber and the tank can be inverted, for example by providing a device wherein a detection chamber is configured to be subsequently crossed by a portion of the sucked air flow that is not condensed inside said tank.

In still other embodiments (not shown), the device is provided with a parallel fluid communication between the detection chamber and the tank.

Said detection chamber is operatively connected to a unit for detecting air quality parameters, for example air quality parameters associated with the sucked air flow that crosses said detection chamber. Said detection chamber is in fluid communication with the outlet of the air flow from the device.

The tank is configured to receive condensed liquid therein and to obtain a sample of condensed liquid, preferably water, captured from the air so as to allow a test of said liquid sample.

In a preferred embodiment said air quality parameter is obtained by means of a test, analysis and/or assays of a liquid sample collected in and/or from the tank.

Said tests, analysis and/or assays, are preferably selected among (but not limited to) the group consisting of: molecular tests, such as nucleic acid based tests, preferably PCR, RT-PCR or RT-PCR multiplex tests and/or DNA sequencing, antigen tests and/or antibody tests, preferably enzyme-linked immunosorbent assay (ELISA), chemiluminescent immunoassay (CIA), lateral flow assay, immunochromatographic assay such as an immunochromatographic test cassette or lateral-flow test cassette, or combination thereof. According to an embodiment, said tests, analysis and/or assays are antigen tests and/or PCR tests, preferably immunochromatographic and/or RT-PCR multiplex assays. In one or more embodiments, the air quality monitoring system includes a passive bio-monitoring data by means of one or more of the above-mentioned tests, analysis and/or assays.

In preferred embodiment, a quality air parameter is associated with a rapid antigen test that is entered manually in the device by the user.

In another embodiment, said air quality parameter is obtained in real-time by means of one or more biosensors provided within said device, for example in correspondence of the air inlet/outlet and/or within the tank, wherein said one or more biosensors are configured to contact the inlet air and/or the liquid sample collected in the tank.

As per the embodiment shown in FIG. 17B, reference is made to the air purifier device as disclosed in PCT/US2019/016440 and in the present description as follows.

In a preferred embodiment, the air purifier device may preferably further comprise moving means (not shown) configured to allow a movement of the device on a surface. Preferably, said moving means comprises a supporting platform on which the device is mounted. The platform may be equipped with motorized wheels.

Preferably, the air purifier device comprises, incorporates or is associated with, the air quality monitoring system including one or more sensors or biosensors for detecting an air quality parameter.

In a preferred embodiment, said sensors may be the above-mentioned satellite devices for detecting an air quality parameter.

When the air purified device is associated with the air quality monitoring system, the latter is preferably configured to provide a signal to said moving means about which are the most polluted areas.

For instance, the device will be moved from a first polluted area to a second polluted area according to the air quality parameters detected. Preferably, said air quality parameters further comprises updatable parameters, e.g. a stationing time of the device in said first or second polluted area and/or a priority logic of the movement of the air purifier device between said first and second polluted area, regulated by the air quality monitoring system.

According to a preferred embodiment, said updatable parameters are obtained by means of artificial intelligence algorithms implemented by the air quality monitoring system and/or the air purifier device.

In certain preferred embodiments, said moving means is equipped with sensors or biosensors that allow the air purifier device to (not limited to) avoid obstacles, recognize people, voice command communication, battery, orientation system, communication system with remote satellite device comprising further sensors for detecting air quality parameters. For instance, said moving means comprises weight sensors, cameras, geo-localizers and/or the like.

In a preferred embodiment, the device shown in FIG. 17A is incorporated with the air quality monitoring system and the air purifier device as illustrated in FIG. 17B.

According to this embodiment, the air purifier device thus comprises a first tank configured to receive liquid therein, as described in detail in the following description, so as to obtain a liquid sample.

Advantageously, the method for detecting and monitoring air quality parameters provided with the invention can comprise the step of collecting said sample of liquid contained in the first tank and testing it for the presence of one or more biological particles.

Preferably, the air purifier device may be configured to receive condensed liquid therein and to obtain a sample of condensed liquid, preferably water, captured from the air so as to allow a test of said liquid sample.

Accordingly, the air purified device may further comprise condensation means and a second tank, intended to be a condenser, namely a tank configured to receive condensed liquid therein.

Advantageously, it is therefore possible to collect a sample of the condensed liquid captured from the air into said second tank, or condenser, and test said sample of condensed liquid for the presence of one or more biological particles.

Preferably, said first tank is in fluid communication with the second tank and the inventive method provides for collecting and testing said sample of liquid and/or said sample of condensed liquid, by allowing a single or double sampling, as will be clarified in the description below.

In certain embodiments, said condensation means of the air purified device may comprise a Peltier cell. Advantageously, the Peltier cell is associated with the condenser and allows a lower consumption with respect to embodiments of the air purifier device wherein it is absent.

Furthermore, the provision of separated but communicating tanks allows to a refilling of the first tank of the device with the condensed liquid collected by the condenser. For example, the condensed liquid of the condenser may feed the first tank of the device.

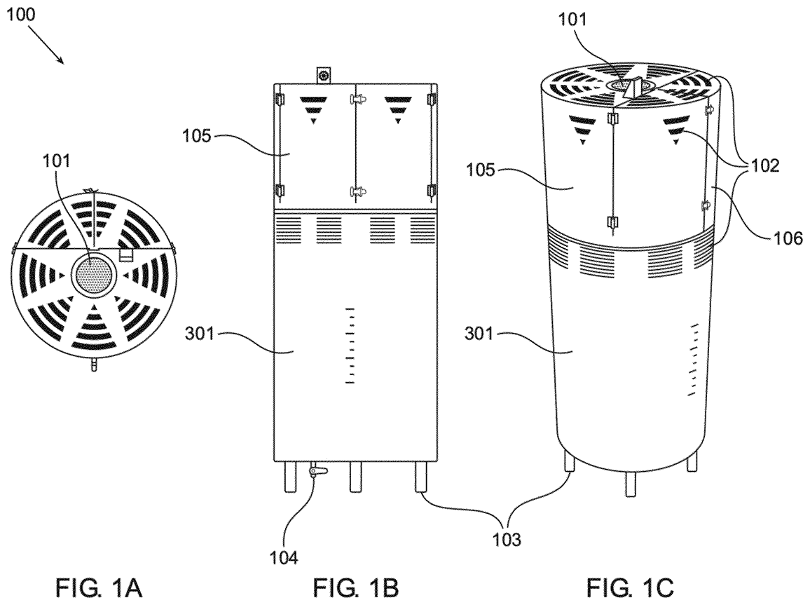

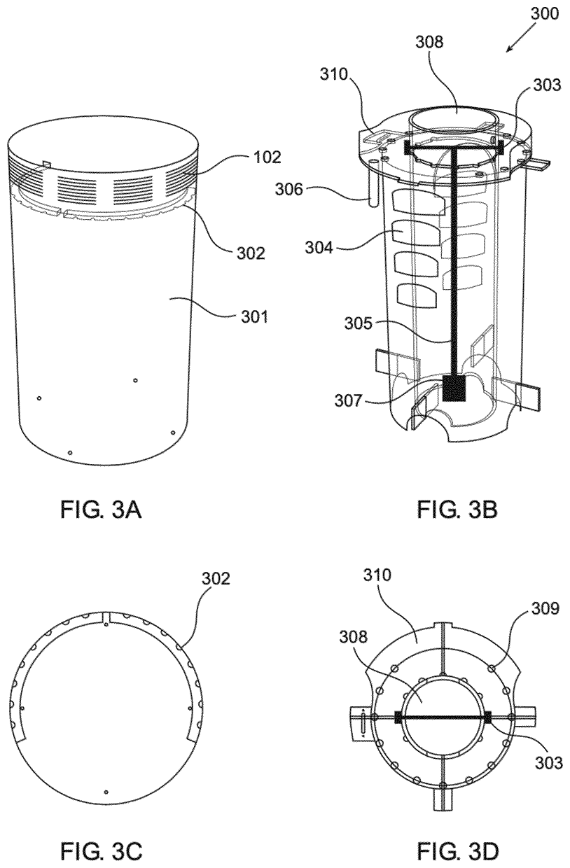

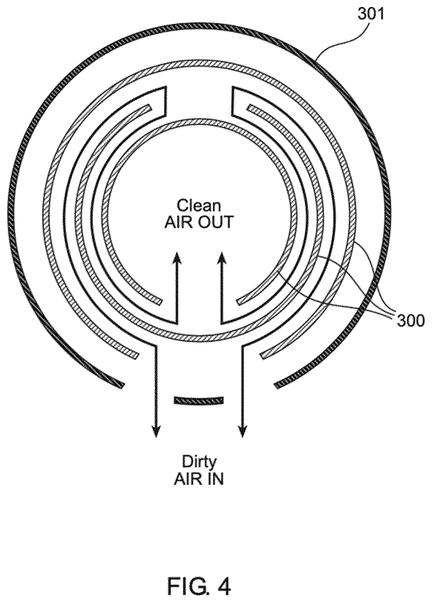

In certain embodiments, a biological air purifier is provided which is made up of one or more of the following components: a first tank, preferably a water tank 301 (FIG. 1), an extractable permanent bio support filter 300 topped with a water-plate 310 having circumferential holes 309 (FIG. 3) that allow distribution, by gravity, of water transferred from the water tank to the bio support filter, a submersible pump 307 with related pipes 305 and T shaped outlets 303 for distributing water within the device, or a water retention bio support material which retains water by shaking the device (portable version), and a vent 204 secured on the top of the central core pipe 308 of the extractable filter 300. The role of vent 204 is to extract air from the core pipe 308 and force the flow around the bio support filter elements (FIG. 4) with the intent of providing oxygen, essential for digestion by bio-oxidation of the captured contaminants, to the microorganism compound additive attached to the bio support filter. The role of the vent 204 is also to create a turbulence around the device to better attract the larger particles which respond to ventilation.

This device can be used to treat air pollution in outdoor and indoor settings, in urban, industrial, medical, corporate, and residential applications.

In a first aspect, the air purification device, comprises:
a tank for accommodating a liquid;
a Bio Support Filter configured to accommodate a biomass additive and comprising an air passageway, the biomass additive configured to digest contaminants within air passing through the air passageway by bio-oxidation;
a pipe system configured to transport the liquid from the tank to the bio support filter, thereby providing moisture sufficient for the biomass additive to digest the contaminants and wash down undigestible matter resulting for bio-oxidation;
   one or more air inlets for allowing contaminated air to enter into the device; and one or more air outlets for discharging purified air.

In one or more embodiments, the bio support filter is shaped to include an air passageway in the form of one or more concentric channels, one or more vertical channels, or a corkscrew.

In one or more embodiments, the device further comprises an electronic control unit, the electronic control unit comprises a communication module for IOT remote control, and/or an air quality monitoring system.

In one or more embodiments, the air quality monitoring system includes one or more sensors for detecting an air quality parameter.

In one or more embodiments, the air quality parameter is selected from a VOC sensor, one or more pollution sensors (such as Particulate Matter sensors), a temperature sensor, a humidity sensor, a dust sensor, a gas sensor, an odor sensor, a radioactivity sensor, and a combination thereof. Additionally, any air quality sensors and other types of sensors can be added including localization, functioning parts remote detection for predictive maintenance, water quality and contamination destruction rate sensors.

In one or more embodiments, the air quality monitoring system includes an access point for transmitting data associated with the one or more air quality. In one or more embodiments, the data transmitted includes data for maintenance and destruction rate of particles, localization, and technologies for voice communication with a device such as Alexa or a voice-controlled device, and including transmitting data and parameters to a cloud-based server for further analysis via a dedicated software.

In one or more embodiments, the device further comprising a vent for coarse contaminants attraction and oxygenation of internal microorganisms compound to enhance bio-oxidation of captured contaminants.

In one or more embodiments, the pipe system includes a pump and a one or more pipes attached to the pump, wherein the pump configured to withdraw the liquid from the tank and to distribute the liquid in the bio support filter via the one or more pipes.

In one or more embodiments, the bio support filter includes a plate onto which the liquid is discharged from the pipes, wherein liquid flows into the bio support filter from the plate via holes within the plate.

In one or more embodiments, the plate includes a protective grid on top of which the biomass additive is disposed.

In one or more embodiments, the device further comprising an outlet tap for releasing the liquid from the tank.

In one or more embodiments, the device further comprising an electro valve for automatic liquid filling.

In one or more embodiments, the device further comprising a tank support base for providing ground support to the tank.

In one or more embodiments, the device further comprising a liquid level sensor for assessing the level of the liquid within the tank.

In one or more embodiments, the device further comprising a top cover for covering internal water sensitive components of the device.

In one or more embodiments, the device is configured to purify air from contaminants having a particle diameter smaller than 0.5 microns.

In one or more embodiments, the air is purified by grounding the suspended particles by “electrical charge attraction”.

In another aspect, PCT/US2019/016440 discloses a method of purifying air, the method comprising providing an air purification device with a biomass additive configured to digest contaminants within contaminated air;
providing an air quality monitoring system, the air quality monitoring system includes one or more air quality sensors being in communication with the air purification device and configured to detect one or more air quality parameters;
detecting and collecting data associated with the one or more air quality parameters; and displaying the one or more air quality parameters on a dedicated dashboard software.

In one or more embodiments, the method further comprising determining a baseline for relative analysis of the one or more air quality parameters.

In one or more embodiments, the method further comprising transmitting the collected data to a cloud-based server using an access point affixed to the air purification device.

In one or more embodiments, the method further comprising analyzing the one or more air quality parameters using the software and/or providing an output of the analysis.

In one or more embodiments, the biomass additive is a nonpathogenic, non-genetically modified micro-organisms consortium additive and/or is configured to transforming contaminants in water and carbon dioxide and elemental base if present.

### DETAILED DESCRIPTION OF THE DEVICE

The description discloses a device for purifying air. The device is based on a biomass additive having microorganisms which can digest air contaminants by bio-oxidation. The device includes a tank filled with water and a bio support filter for accommodating the biomass additive. The tank supplies moisture for the microorganisms in the bio support filter via a pump and related pipes and a vent supplies oxygen to the bio support filter to enhance the digestion process of the captured contaminants by bio-oxidation while attracting also coarse particles. The bio support filter includes one or more air passageways within which contaminated air may pass and come into contact with the microorganisms.

The disclosed device is unique and advantageous when compared with other known devices and solutions because it provides a unique plug-and-play solution for every kind of contaminant regardless of particle size or type. The device is configured to purify air from contaminants including, but not limited to, pathogenic bacteria and viruses, Volatile Organic Compounds, odorous gases, oil mist, mold and spores, fine dust including particles smaller than 0.5 microns, heavy metals, chemical compounds, hydrocarbons, black carbon, etc.

The unit is unique because: 1) it uses water and nonpathogenic, non GMO bacteria consortium to operate; 2) all contaminants are attracted and captured by the unit by “molecular electric charge” triggered by the Potential Energy Field naturally generated by the internal Bio Support shape and characteristic; 3) once the pollution is captured by the unit, the bacteria within the unit completely destroy the captured pollutants by bio-oxidation, naturally transforming the compounds in water and carbon dioxide such as for example: 2 C6H6+15 O2 becomes 12 CO2+6 H2O; 4) there are no membranes which get saturated compromising efficiency and no filters, lamps of cartridges to be changed; and 5) the unit relies on tap water, air and a harmless blend of non-GMO, nonpathogenic bacteria to destroy large loads of air pollution without turning it into harmful byproducts.

Similarly, the disclosed method is unique when compared with other known processes and solutions in that it: 1) combines the unit with a separate air quality sensor which independently detects air pollutants without interfering with the unit operations; 2) has and integrated localization and operational sensor system for remote assistance and predictive maintenance connected to IoT and 3) has a method of calculating carbon footprint equivalence based on operational time per unit size providing a specific Pure Air Index calculation system.

This equivalence has been estimated and compared depending on the size of the unit and achieved between 276 and 6000 trees pollution removal efficiency per unit. In one or more embodiments, the herein disclosed device achieves at least about 276 trees pollution removal efficiency per unit. For example, the device achieves at least about 276, 300, 400, 500, 600, 700, 800, 900, 1000, 1500, 2000, 2500, or 3000, up to 6000 trees pollution removal efficiency per unit.

The disclosed device and system are unique in that it is structurally different from other known devices or solutions. More specifically, the device is unique due to the presence of: water, forced air flow through the bio Filter by ventilation digesting air pollution using bacteria, and an IoT Air Monitoring System.

An embodiment includes a device made up of the following components: a) top cover 105 (with optionally electronic-electrical control-data communication); b) vent 204; c) water plate 310 with protective grid 203; d) bio support filter 300; e) pump 307 and related piping 305, 303; f) Tank 301; g) tank support base (optionally forklifted) 103; h) water outlet tap 104 or electro valve 106; i) water inlet tap 106 or electro valve, which is an inlet valve accessible from the outside cover to be connected to a water pipe (water mains); j) tank thermic coat with temperature sensors; k) biomass additive dispensers on a grid 203 attached to the cover 105; l) internal web cams; m) water level sensors (mechanical-optic or ultrasound) 306; and n) temperature-humidity-pH sensors.

These components are optionally connected as follows: the head element/top cover contains all the electronic and electrical elements which could be sensitive to water, secured in a container having appropriate wiring, and can be separated from all the other components of the unit. The vent may be a separate element secured to the Bio Support core element and connected to power the top cover element. The Bio Support can be completely removed and extracted by the tank element. Pump and related piping with faucets for water flow regulation, water level sensors, and pH sensors are connected to the Bio Support and can get detached from electron power source by fast cable connectors; and the tank and tank base are connected and are optionally provided with a tap to release water.

It should further be noted that the unit can be connected to the water mains for automatic refilling. There is no need for air ducting or hoods.

The method associated with the disclosed device can comprise the following steps: install the Air Quality Monitoring System 200 for a baseline period of collection data; install and turn on the biological air purifiers; detect air quality improvements 800 through related software dashboard; display results in the installed unit network on the map in the APP.

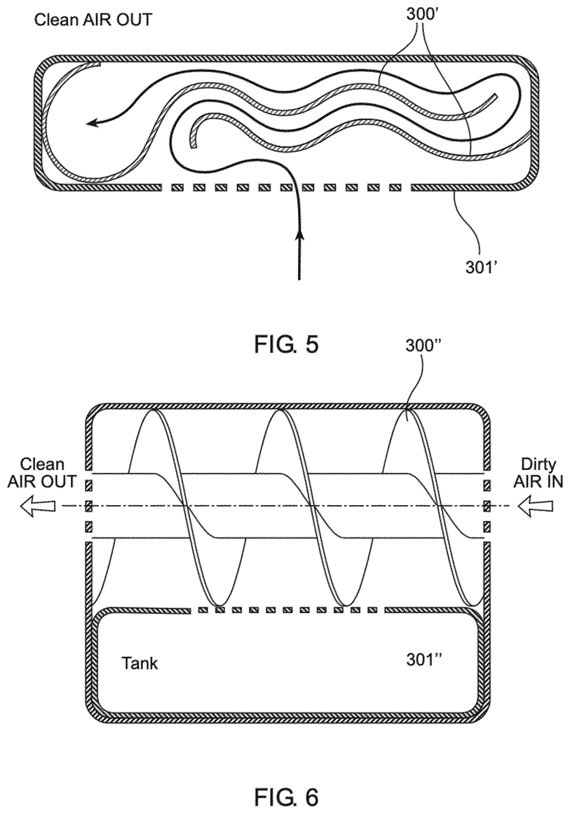

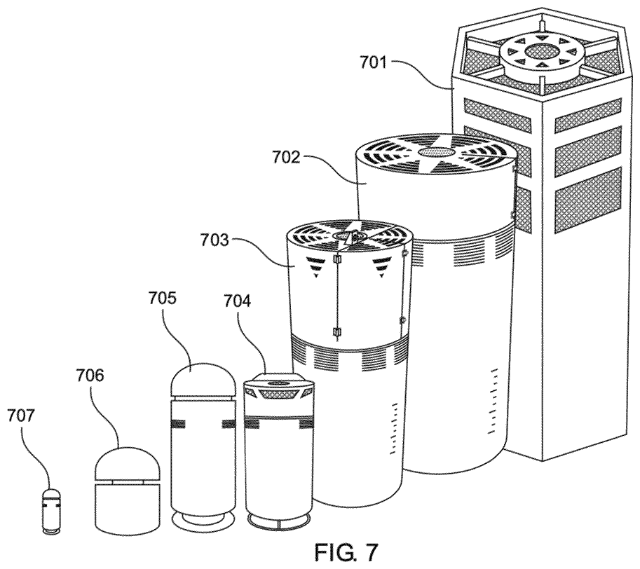

The device may also have one or more of the following variants of elements and features: the Bio Support shape can be, but is not limited to, two or more concentric circles (FIG. 4); two or more vertical multilayers (FIG. 5); and corkscrew (FIG. 6).

The Bio Support shape can be made of different materials, including but not limited to: food grade plastic, activated carbon support/sponge, absorbent natural or synthetic fabric, stainless steel, or any combination of the above materials.

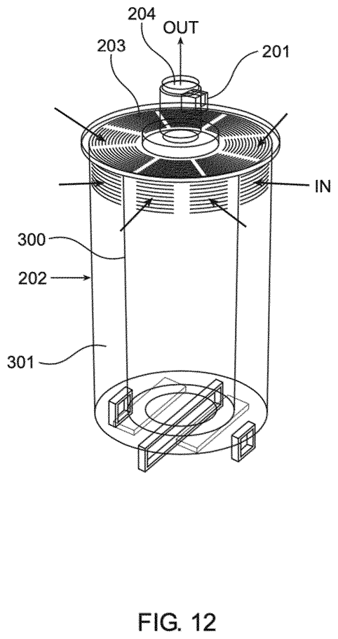

Water transmission inside/to the unit may be accomplished by the following techniques: a) water can be pulled by a submersible pump on the bottom of the tank and transferred through piping to a water plate with holes placed on top of the Bio Support in order to keep it constantly moist; and b) water can be distributed by gravity on the Bio Support by simple motion on the water plate. In the system, the water gets sucked by the pump on the bottom of the tank up through the T shaped piping to two or more T shaped outlets discharging on the water plate. The water then fills the water plate, flows through the water plate holes and along the sides of the bio support to moist the microorganisms additive attached to the biofilter surface exposed also to air flow generated from the vent by gravity back down to the tank (see FIG. 11).

Oxygen supply to the unit internal parts can be provided by one or more vents by suction (air outlet) and forced into the bio support through related conveniently located air circulation holes (air inlets) shown in FIG. 3.

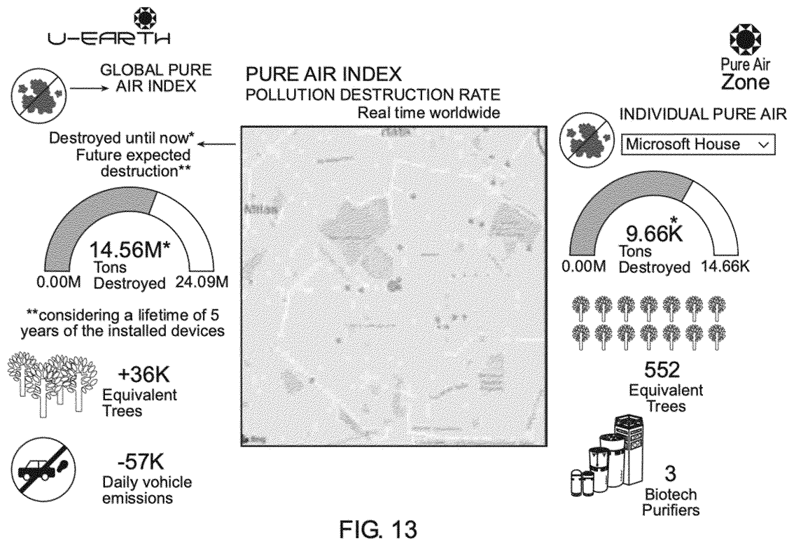

As shown in FIG. 4, the combination of air flow (tangent exposure of the bio support to oxygen) and water flow (gently washing undigestible remaining elements down to the bottom of the water tank, which happens inside/around the biofilter, is one of the key aspects to the technology. The combination of air flow and water flow creates “ideal ecosystem” (based on calculated air and water flow combined circulation, which provides a specific consortium of selected microorganisms, acting as “IMMOBILIZED cells” on the Bio Support, to greatly enhance contaminant digestion by bio-oxidation performance. FIG. 12 shows the direction of airflow into the tank.

In certain embodiments of the system the microorganisms are designed to die after 30 days and are required to be added to the water (singular-dose bottle poured in the core pipe) every 30 days. Water will evaporate by effect of bio-oxidation and (if manual) the tank must be refilled periodically (averaging every 7 days).

External materials for covering the unit may be, but are not limited to, on or more of aluminum, steel, leather, wood, fabric, plastic etc.

Operational unit features in the system may include one or more of: an electronic control of operations such as, but not limited to, a) electro valve for automated refilling 106; b) PH water sensor; c) water level control trough mechanical, optic, ultrasound or humidity sensors 306; d) remote control data transmissions to the Cloud (IoT) or Blockchain Network via GSM, LoRaWAN, WIFI, Ethernet 201.

Similarly, the associated method may also include one or more of the following steps: connection to an APP for: a) remote control of unit and Air Quality Sensors; b) pollution destruction calculation based on operational time; c) notification of unit needs such as additive addition and clean up calendar; d) location on a geographical map; e) connection in real time to after sales service team through video; and f) Augmented realty technology for units servicing aid and other useful or communication content.

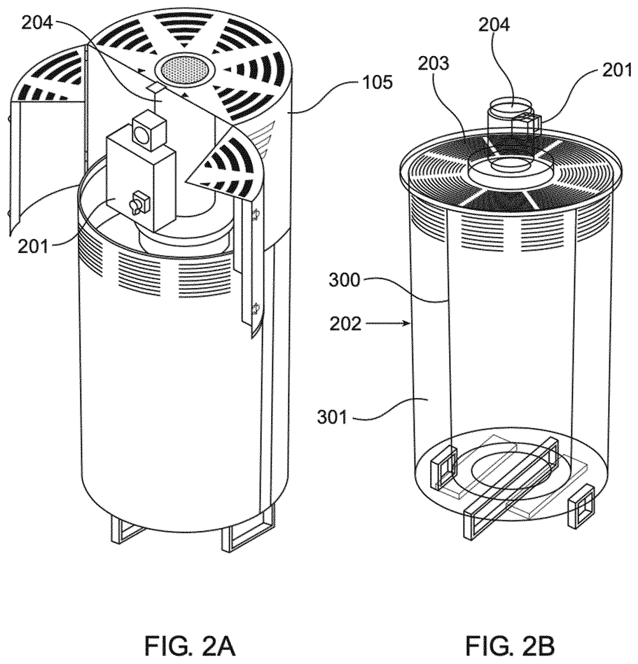

Referring now to the drawings, FIGS. 1A-1C illustrate external views of an exemplary embodiment of a device as herein disclosed. The device 100 is composed of a tank 301 placed on a base 103 and topped with a cover 105. The Air is forcefully sucked from top and lateral air inlets 102 into the internal bio support filter 300 (shown in FIG. 3). Decontaminated air exits the device 100 from a top outlet 101. The tank 301 can be filled with tap water either through the water inlet equipped with an automated electronic valve 106 and connected to a water main(s), or directly poured on the internal water plate 310 (FIG. 3D) through the protective grid 203 (FIG. 2B). Water can be discharged through the tap 104 placed on the bottom of the unit. The unit 100 is designed to remain operating continuously (24/7).

Internal portions of the device 100 are demonstrated in FIGS. 2A-2D.

Opening the top cover 105, there is access to control board 201 which includes electronic control components and vent 204. The control board 201 includes a communication module to remotely control the operation of the device and have the predisposition to be integrated to existing PLC in industrial settings. The bio support filter 300 is placed inside the unit tank 301. The Air Quality Monitor 200 can be connected in parallel with the unit installation to detect and track air pollution abatement performance and dynamics. A pre-dosed microorganisms additive, optionally in liquid form needs to be periodically added to the device 100, every 30 days by pouring it directly on the internal protective grid 203. The tank 301 can be filled with tap water until maximum level 202 is reached.

In FIGS. 3A-3D detailed illustration of the bio support filter 300 is shown. Bio support filter 300 is placed inside the unit tank 301 and the vent 204 (shown in FIG. 2) is fitted and disposed on the central core pipe 308 of the filter 300. The tank 301 and bio support filter 300 are two separate components of the device 100. The tank 301 has air inlet holes 102 for optimal ventilation of the bio support. The bio support filter 300 component is equipped with a submersible pump 307 and related piping 305, a water plate 310 for water distribution on the bio support filter 300, and conveniently shaped holes 304 for best fluid dynamics flow inside and throughout the bio support filter 300. The water gets pumped up the piping 305 from the bottom of the tank 301 to the water plate 310 and evenly distributed by the T junction pipes 303 and back down (by gravity) wets the Bio Support 300 through the holes 309. The bio support filter 300 may be additionally equipped with water level sensors 306 which can be mechanical, optic, or ultrasound. The tank 301 may be further equipped with a further drip border 302 which, once the bio support filter 300 is inserted in the tank 301 the side of the tank can act a further surface for the biomass additive to stick and become active. FIGS. 5-7 illustrate possible shapes of air pathways within the bio support filter 300. One possible shape of air passageway in the bio support filter is one or more concentric circles. The air gets sucked from the vent secured on the internal core pipe of the Bio Filter which forcefully sucks the air throughout the holes on the Bio Support layer from the external air inlet holes (FIG. 5).

Another possible shape of the Bio Support is Vertical Multilayers. The air gets sucked from the vent secured on the side core pipe of the Bio Filter which forcefully sucks the air throughout the layers of which the Bio Support is made from the external air inlet holes (FIG. 6).

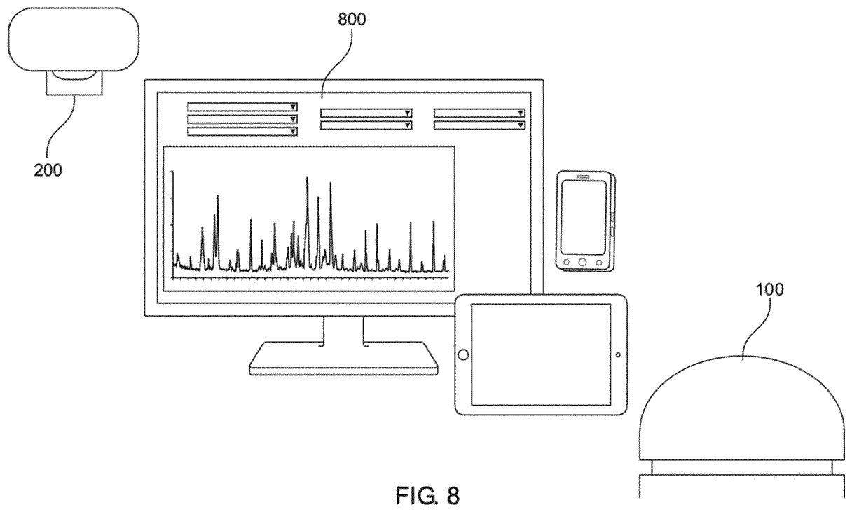

Another possible shape of the Bio Support is Corkscrew motion. The air gets sucked from the vent secured on the side core pipe of the Bio Filter which forcefully sucks the air throughout the layers of which the Bio Support is made from the external air inlet hole on the opposite side (FIG. 7).

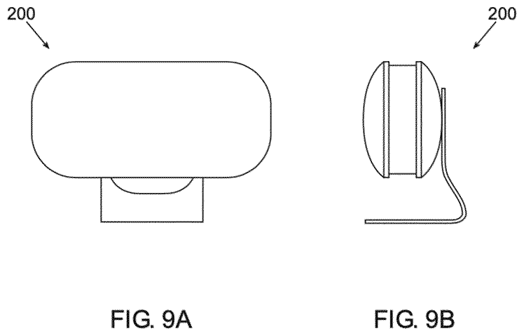

FIG. 8 illustrates air purification devices 701, 702, 703, 704, 705, 706, and 707 demonstrating various shapes, and sizes. The device can be produced in different sizes and shapes to better suit any kind of application and environment. The units may be used in urban settings (e.g., device 701), in the industry (e.g., devices 702 and 703), in a corporate setting (e.g., device 705), in the medical setting (e.g., device 704), for personal use (e.g., device 707), and in residency (e.g., device 706). The units, depending on the size and/or shape are applicable to cover a wide range of area. For example, the unit may cover an area of at least 40 square meters. The unit may cover an area in the range of at least 40 square meters and up to 70 m diameter. For example, the units are intended for use in: urban settings 701 and may include an external robust material such as stainless steel or plastic, such unit may provide protection nets for external elements such as leaves and debris and may cover up an area of 50-70 m diameter. In a further exemplary embodiment, the units may be used in industrial sites, such units may be equipped with electronic control of operations and top cover 105 protection, and may cover an area of around 500 square meters. In a further exemplary embodiment, the units may be used in the medical setting, such units may be equipped with automated water refilling system and electronic touch screen control and may cover 70-150 square meters. In yet a further exemplary embodiment, the units may be used in corporates 705, thus may be equipped with automated shut down of the unit once the water level goes below the minimum level and may cover 70-150 square meters. In yet a further exemplary embodiment, the units may be used in residential 706 suitable for countertop and may cover 40-90 square meters. In yet another exemplary embodiment the unit may be used for personal 707, and include portable unit for personal protection in car, baby stroller, train, plane, subway, office, etc. The device is used to purify immediate area surrounding the device regardless of it being in an outdoor or confined area. This is advantageous as it works in tight spaces and spaces where air is stagnant, and quality of air is required to be improved.

The units can externally be made in any possible material depending on intended field of use.

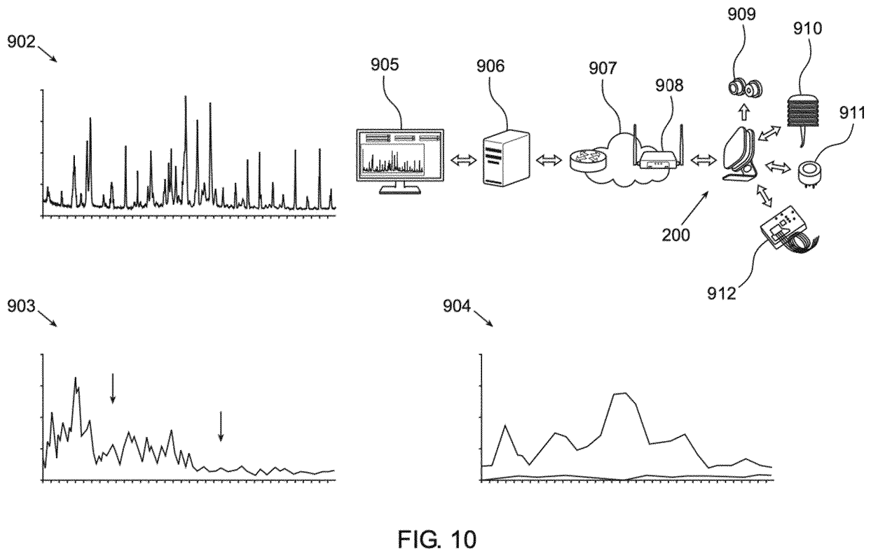

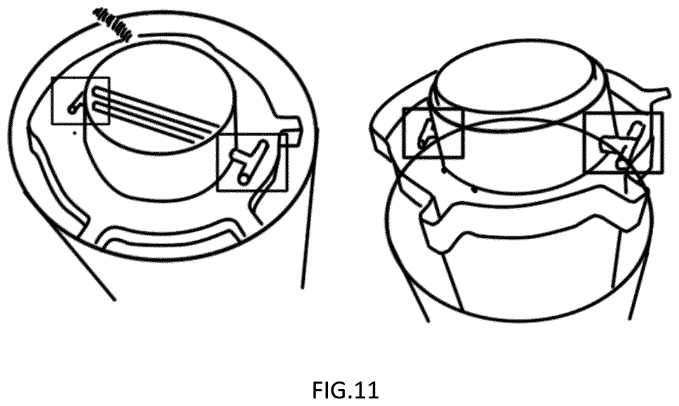

FIGS. 9-11 illustrate embodiments of the device which include a device 100 composed of an independent Air Monitoring system 200 which collects data from specific sensors and sends them to the cloud where a software control dashboard 800 can be accessed from any mobile device or computer for interrogation confirming the performance of the device 100. The presence of the system in an area is signaled to the visitors by featuring a specific logo on the entrance door 801 and included in a WEB and APP public MAP showing location and Pure Air Index performance calculation of the installed system for marketing and sustainability purposes.

Air Quality Monitoring System 200 can detect many different parameters by including various sensors 909, 910, 911, 912, including but not limited to: VOC, NO2, CO, CO2, odorous gases, PM2.5, PM1, radon, radioactivity, temperature, humidity, etc. The Air Quality Monitoring System 200 can communicate the data through GSM, WIFI, Ethernet and LoRaWAN. The data sent to an access point 908 through the internet 907 and is stored on could servers 906 and consulted through a dashboard 905 where a software releases various forms of possible data aggregation 902, 903, 904.

In certain embodiments, the components of the system are installed separately. The present description relates to a device and a method associated with the device. With respect to the device, it is a biological Air Purifier, which captures air contaminants without limit of size and type by “electric molecular charge attraction” and then digests the captured contaminants by bio-oxidation by means of a microorganism compound additive. The unit can be used in combination with a custom developed Air Quality Multiple Sensor hardware, which sends the collected data to the cloud, which is then consulted through a proprietary dashboard software. This device can be used to treat air pollution in outdoor and indoor settings, in urban, industrial, medical, corporate, and residential applications. The core components of the device are electricity operated bioreactor where air and water circulate due to a pump and a fan, a biological non-GMO, non-pathogenic pollution eating compound to be added periodically to the bioreactor and a device which includes various Air Quality sensors connected to the Cloud. The device includes a monitoring device is set up to control in real time several Air Quality parameters then elaborated by a software in cloud for consultation through an interactive dashboard displaying periods, different contaminants separately detected with sensors such as—but not limited to—humidity, temperature, PM1, PM2.5, odorous gases, carbon monoxide, carbon dioxide, NO2, Volatile Organic Compounds, radon, radioactivity etc. An algorithm based on the maximum destruction potential by bio-oxidation of every unit, multiplied by the operational time releases an impact coefficient to compare pollution destruction efficiency between users/locations. The second core component is the installation of the bioreactor, a free-standing unit which is located close to the air pollution emission source or in the middle of an area to be treated. The combination of the biological air purifiers and conveniently located monitors can detect the rate of action of the clean air zone created by every unit or cluster of units and the dynamics of air pollution travelling to the unit and being destroyed. With respect to the device it should be further noted that the internal components of the device are where the pollution eating bacteria find the ideal conditions to perform pollution destruction by bio-oxidation. In order to carry out the method the following core steps are followed: the monitoring device set up is the first step of the system, installed in order to detect a baseline of existing air pollution conditions, the second step is the installation of the bioreactor, a free standing unit which is located close to the air pollution emission source or in the middle of an area to be treated. The continued detection of improvement and general conditions of the air quality in the area treated by the system (bioreactor+air monitor) is used to provide a “certified” air quality level to the treated space and a related Pure Air Index showing daily and cumulative since installation destruction rate. Ultimately, at the conclusion of these steps a new Air Quality Standard can be assured for safer, low concentration exposure areas. The system can be included in sustainability reports for companies and its efficiency measures against carbon footprint parameters.

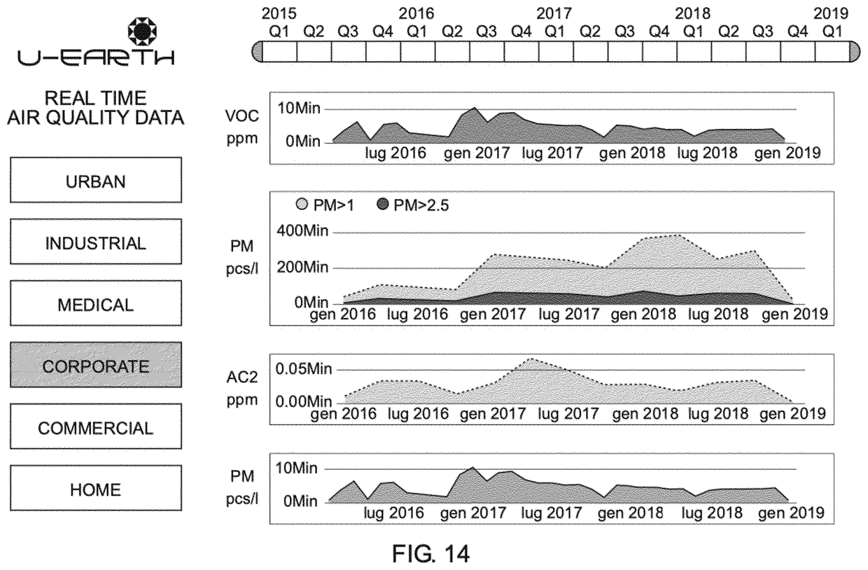

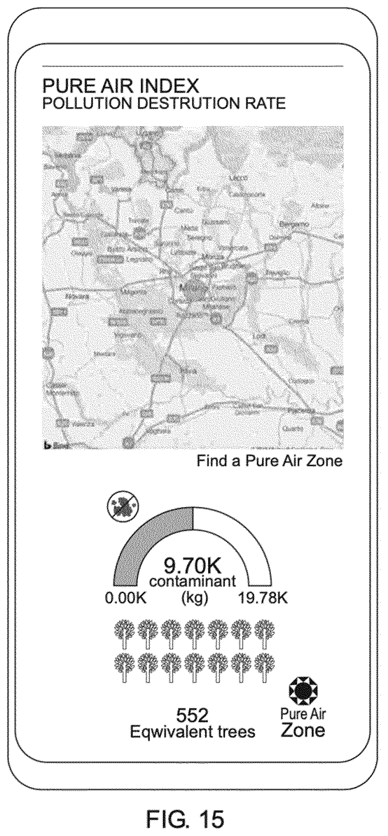

FIGS. 13-14 show a chart a of a pollution index and real time air quality data.

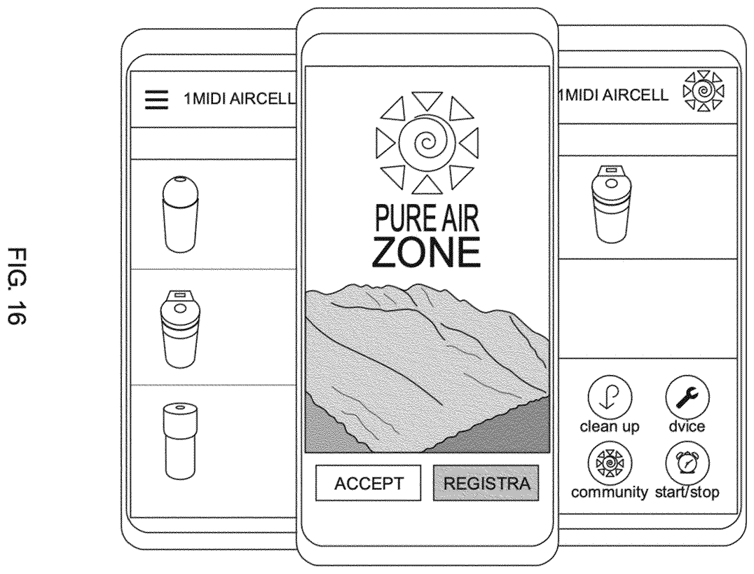

FIGS. 15-16 are photographs of a software application that works with the system.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

### The Air Monitoring Systems and Methods of the Present Invention

From the above-mentioned International Application is merely known that the bioreactor can be used as an air purification device in that the biomass additive contained therein is able to digest air pollutants in general. However, there is no hint in there about its use for the detection and/or digestion of biological particles, let alone viruses such as the SARS-CoV-2.

As mentioned above, in the context of the experiments carried out by the inventors during the COVID-19 outbreak, the device better defined below, or according to anyone of the embodiments disclosed in the international Patent Application No PCT/US2019/016440, proved to be surprisingly useful also as air monitoring system, particularly for sampling and detecting biological particles or bioaerosol dispersed in the air.

More in particular, the inventors realized that by analyzing the liquid present in the collecting means of the device disclosed in the International Patent Application No PCT/US2019/016440, here below also referred to as “bioreactor” or “AIRcel”, by means of any of the techniques known in the art, it was surprisingly possible to detect the presence of the SARS-CoV-2, besides other biological particles, particularly viruses, as defined above.

Without wishing to be bound to any theory, the inventors think that the biomass additive within the bioreactor does not immediately digest the biological particles or agents but rather there is a lag-time wherein they are still viable and/or detectable within the tank liquid. The device initially attracts/includes the particles and the relative atmospheric particulate, therefore it acts in a non-selective form in the inclusion phase, while it acts biologically by later digesting the captured biological pollutants and volatile compounds in combination with the co-formulants contained in the biomass additive. In order to bio-detect (in the water tank after capture and before complete destruction) the presence of RNA traces of harmless inactivated viral strains and pathogens through rapid test or PCR, in respect to the additive already mentioned in the International Application, a different biomass additive formulation has been developed which consents a longer complete digestion phase or the target contaminants would be difficult to detect after their capture.

The biomass additive of the device of the present invention is a nonpathogenic, non-genetically modified micro-organisms consortium additive. According to an embodiment, the consortium can comprise a stable variable mix of aerobic and/or anaerobic species, fungi and yeast, both from natural sources and from specific selected strains preferably selected among the group comprising, but not limited to: Bacillus specie (spp), Lactobacilli spp, Actinobacteria spp, Proteobacteria spp, Cianobacteria spp, Deinococcus spp, Clorobacteriacee, Spirochaetalea and/or mixtures thereof. According to an embodiment, the biomass additive can further comprise one or more co-formulants preferably selected among the group comprising, but not limited to: quartz, anthracites, carbonates, silicates, metal ions and salts, protein extracts, enzymes, amino acids, natural extracts in general and mixtures thereof. The biomass additive of the present invention allows for a longer digestion time in that the co-formulants are able to block and inactivate the target contaminants for at least 3 days. Besides this, the inventors also found that by modifying the device disclosed in the International Patent Application No PCT/US2019/016440, particularly by adding a tank configured to receive therein liquid condensed from the air, the effectiveness of said device can be increased. A first advantage is that the need to replenish the water tank of the device is avoided or reduced (i.e. the device condenses a greater amount of water in the tank thus lowering the humidity and limiting the consumption of water inside the device). Secondly, since biological particles, particularly viruses, can have as a carrier both drops of moisture (captured by the condenser) and Particulate Matter (captured by the device by molecular charge attraction) the sensitivity of the method is dramatically increased due to the fact that the device according to the invention is able to attract not only Particulate Matter (captured by the device by molecular charge attraction) but also drops of moisture (captured by the condenser) in a more effective way.

Therefore, the present invention also refers to a device comprising:
collecting means (for example one or more tank) configured to receive a liquid therein;
a bio support filter configured to accommodate a biomass additive and comprising an air passageway, the biomass additive configured to digest contaminants within air passing through the air passageway by bio-oxidation;
a pipe system configured to transport the liquid from the collecting means to the bio support filter, thereby providing moisture sufficient for the biomass additive to digest the contaminants;
one or more air inlets for allowing contaminated air to enter into the device; and one or more air outlets for discharging purified air;

According to an embodiment, the collecting means of said device comprise a first tank configured to receive therein liquid and/or a second tank configured to receive therein condensed liquid captured from the air. The first and second tank of said device can also be in fluid communication.

In other words, the invention also refers to a device according to any of the embodiment disclosed in the International Patent Application No PCT/US2019/016440 further comprising a second tank configured to receive therein condensed liquid captured from the air (e.g. a condenser).

Also, the present invention refers to a method for detecting and/or monitoring the presence of biological particles in the air, the method comprising the following steps:
providing a device as herein described, or a device according to any of the embodiments disclosed in the International Patent Application No PCT/US2019/016440;
optionally collecting a sample of liquid from the collecting means of said device; and
testing said sample of liquid for the presence of one or more biological particles.

Said biological particles can be selected, for example, from the group consisting of bacterial cells and spores, viruses, pollen, fungi, algae, detritus, allergens, protozoa, parasites, and/or cell fragments comprising nucleic acids, proteins and toxins. Said viruses can be selected, for example, among the group comprising, but not limited to: coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus.

In particular, according to an embodiment, the present invention refers to a method for detecting and/or monitoring the presence of biological particles in the air, the method comprising the following steps:
providing a device comprising:
collecting means configured to receive a liquid therein;
a bio support filter configured to accommodate a biomass additive and comprising an air passageway, the biomass additive configured to digest contaminants within air passing through the air passageway by bio-oxidation;
a pipe system configured to transport the liquid from the collecting means to the bio support filter, thereby providing moisture sufficient for the biomass additive to digest the contaminants;
one or more air inlets for allowing contaminated air to enter into the device; and one or more air outlets for discharging purified air;
collecting a sample of liquid from the collecting means of said device; and
testing said sample of liquid for the presence of one or more biological particles.

The collecting means of said device can comprise a first tank configured to receive therein liquid and a second tank configured to receive therein condensed liquid captured from the air. Therefore, the invention also refers to a method comprising:
collecting a sample of liquid from the first tank and/or a sample of condensed liquid from the second tank; and
testing said sample of liquid and/or sample of condensed liquid for the presence of biological particles.

The first and second tank of said device can also be in fluid communication.

Therefore, the invention also refers to a method comprising:
collecting a mixture of said sample of liquid and sample of condensed liquid; and
testing said mixture for the presence of biological particles.

As already mentioned above, said biological particles can be selected, for example, from the group consisting of bacterial cells and spores, viruses, pollen, fungi, algae, detritus, allergens, protozoa, parasites, and/or cell fragments comprising nucleic acids, proteins and toxins. Said viruses can be selected, for example, among the group comprising, but not limited to: coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus.

According to any of the embodiments of the present invention, said collecting step can be carried out continuously or discontinuously, and/or manually, for example by means of a pipette, or automatically for example by means of a probe.

According to any of the embodiments of the present invention, said collecting step can be:
a simple sampling meaning that the liquid sample can be either a sample of liquid collected from the first tank of said device (which can comprise also the biomass additive) or a sample of condensed liquid collected from the second tank of said device; or
a double sampling meaning that the liquid sample can be either
   1. a sample of liquid collected from the first tank of said device (which can comprise also the biomass additive) and a sample of condensed liquid collected from the second tank of said device to be tested alone, together or one after the other, or,
   2. when the first and second tank are in fluid communication, a mixture of the sample of liquid collected from the first tank of said device (which can comprise also the biomass additive) and the sample of condensed liquid collected from the second tank of said device.

As already explained above, since viruses, particularly that of SARS-CoV-2, can be present both on water droplets (captured by the condenser) and on Particulate Matter (captured by the molecular electric charge attraction of the biomass additive), the double sampling increases the chance to detect the virus when the sample are tested.

According to any of the embodiment of the present invention embodiment, said sampling is carried out by turning off the device (e.g. 10 minutes before sampling), collecting a liquid sample from the internal water plate (or tanks) of the device by means of a sterile probe, and inserting the collected liquid sample in a sterile test tube (e.g. sterile Falcon tube, 50 mL). When the liquid sample is not tested immediately (for example by means of a immunochromatographic test cassette) but rather is sent to laboratories for further analysis (e.g. RT-PCR analysis), said sampling can also comprise disinfecting the surface of said test tube (e.g. with sodium perchloride, 1.050 ppm free chlorine, Amuchina Bleach wipes) and inserting the tube into a dry, sterile, and well-sealed plastic bag for shipping.

According to a preferred embodiment of the invention, the samples of liquid are tested immediately after sampling. For instance, the sample of liquid can be collected from the water recirculation outlet placed on the internal water plate of the device or from the first and/or second tank of the device with a pipette and then either transferred in a sterile container for the lab PCR testing and/or used immediately by dripping a few drops in the rapid test cassette providing results in 15 minutes.

However, in cases where it is not possible to do so, the sample can be stored for example in a dry, sterile, and well-sealed plastic bag. This way the sample is stable up till 8 hours at ambient temperature and up till 24 hours at 2-8° C.

According to any of the embodiments of the invention, the method can further comprise the step of processing the collected sample by adding a collection liquid and/or a preservative to the sample; and/or by freezing the sample. For biomolecular type analysis, freezing of the sample is preferred.

Said collection liquid can be any collection liquid know in the art to be useful for processing and/or preserving biological particles, and is preferably selected among the group consisting of: sterile distilled water, physiological saline, phosphate buffered saline (PBS), nutrient broth, peptone water, Dulbecco's Modified Eagle's Medium (DMEM) or mixtures thereof and is preferably.

Said preservative can be any preservative known in the art to be useful for processing and/or preserving biological particles and is preferably selected among the group consisting of: antibiotics preferably streptomycin and/or penicillin, anti-foam agents, preferably isoamyl alcohol, inactivants in general and mixtures thereof.

According to any of the embodiments of the invention, said testing step is carried out by subjecting the liquid sample to one or more tests, analysis and/or assays known in the art to be useful for the detection of the presence of biological particles.

Testing can be carried out in situ and/or demanded to dedicated laboratories according to any of the methods known in the art as suitable for the qualitative and/or quantitative analysis of biological samples such as PCR-based assays, nucleic acid sequencing, protein expression assays, immunoassays, mass spectrometry, in vivo or in vitro bioassays, chemical analyses, ATP assays, microarray analyses, scintillation counting, and use of a Geiger counter etc.

According to an embodiment, said testing step is carried out by one or more test and/or analysis and/or assays preferably selected among the group comprising, but not limited to: molecular tests, such as nucleic acid based tests, preferably PCR, RT-PCR or RT-PCR multiplex tests, and/or DNA/RNA sequencing, antigen tests and/or antibody tests, preferably enzyme-linked immunosorbent assay (ELISA), chemiluminescent immunoassay (CIA), lateral flow assay, immunochromatographic assay such as an immunochromatographic test cassette or lateral-flow test cassette or combination thereof. According to an embodiment, said tests, analysis and/or assays are preferring selected among antigen tests cassette, such as an immunochromatographic test cassette and/or PCR analysis, preferably RT-PCR multiplex assays.

According to a preferred embodiment, said testing step is carried out by collecting a sample of liquid from one or more tank of the device herein disclosed, e.g. by means of a pipette, and by adding drops of the collected sample on the testing well of an antigen test cassette. The thus obtained results can be confirmed by further subjecting the same sample of liquid to RT-PCR analysis.

According to any of the embodiments of the invention, the method can further comprise the step of signaling the presence of one or more biological particles, preferably wherein said signaling is carried out by providing the device with a test, such as for example an antigen test cassette, and an optical sensor, the sensor being in communication with the test and configured to detect and discriminate the result of the test. In fact, it is possible to connect an optical sensor for the detection of the results in chemiluminescence equipped with UV LED and data transmission system. The signaling can be also carried out by providing the device with one or more biosensor(s), such as for example an antibody-based biosensor, configured to interact with the biological particle(s) and produce a detectable signal, for example an optical or electric signal.

The signaling step can further comprise displaying the result on a dedicated dashboard software and/or transmitting the result to a cloud-based server using an access point affixed to the sensor and/or analyzing the result using the software optionally providing an output of the analysis.

As already mentioned above, said testing can be carried out in situ and/or demanded to dedicated laboratories according to any of the method known in the art to be suitable for the qualitative and/or quantitative analysis of biological samples such as, for example, those defined above.

However, in cases where a prompt response is of outmost importance, for example during a pandemic, rapid tests such as those known as rapid test cassettes, are preferred.

Therefore, the present invention also refers to kit of parts comprising the device as herein described, or according to any of the embodiments disclosed in the International Patent Application No PCT/US2019/016440, and a test configured to detect the presence of one or more biological particles, such as for example those defined above. A kit for saliva based antigen rapid test could be provided as well, to be used on humans frequently present in the area where the bio-detection on the unit has tested positive, to immediately assess the possible human source of infection.

More in detail, the kit of parts of the present invention can comprise a device comprising:
collecting means configured to receive a liquid therein;
a bio support filter configured to accommodate a biomass additive and comprising an air passageway, the biomass additive configured to digest contaminants within air passing through the air passageway by bio-oxidation;
a pipe system configured to transport the liquid from the collecting means to the bio support filter, thereby providing moisture sufficient for the biomass additive to digest the contaminants;
one or more air inlets for allowing contaminated air to enter into the device; and one or more air outlets for discharging purified air;
   and a test configured to detect the presence of one or more biological particles, such as those defined above.

As already mentioned above, the test, as well as the any other sensor or biosensor configured to detect the presence of one or more biological particles in the liquid comprised in the collecting means of the device, can be also provided within the device, for example within the collecting means of said devices, and/or in correspondence of the bio-support filter.

According to an embodiment, the test cassette is an IgA and/or IgG and/or IgM test cassette specific for one or more of the following viruses: coronaviruses, in particular beta-coronaviruses, more in particular SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus, still more preferably SARS-CoV-2. According to a preferred embodiment, the test cassette is a SARS-CoV-2 IgA and/or IgG and/or IgM test cassette.

The kits of parts according to any embodiments of the present invention can also comprise means configured to collect a sample of liquid from said device, preferably wherein said collecting means are selected among the group comprising, but not limited to: pipette, air displacement pipettes, electronic pipette, positive displacement pipette, volumetric pipettes, graduated pipettes, Pasteur pipette and the like.

The invention also refers to a device or a kit of parts according to any one of the embodiments disclosed herein, for detecting and/or monitoring the presence of biological particles in the air by testing the liquid of one or more collecting means of said device, wherein said biological particles are preferably selected among the group consisting of bacterial cells and spores, viruses, pollen, fungi, algae, detritus, allergens, protozoa, parasites, and/or cell fragments including nucleic acids, proteins and toxins, and wherein said viruses are preferably coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus.

Advantageously, when the test provided in the device is a biosensor, the collecting step of a sample of liquid can be skipped. Therefore, the present invention also refers to a method for detecting and/or monitoring the presence of biological particles in the air, the method comprising the following steps:
providing a device comprising:
   collecting means configured to receive a liquid therein;
   a bio support filter configured to accommodate a biomass additive and comprising an air passageway, the biomass additive configured to digest contaminants within air passing through the air passageway by bio-oxidation;
   a pipe system configured to transport the liquid from the collecting means to the bio support filter, thereby providing moisture sufficient for the biomass additive to digest the contaminants;
   one or more air inlets for allowing contaminated air to enter into the device; and one or more air outlets for discharging purified air; and
testing a sample of liquid from the collecting means of said device for the presence of one or more biological particles.

As already explained above, the collecting means of said device can comprise a first tank configured to receive therein liquid and a second tank configured to receive therein condensed liquid captured from the air and accordingly the method can comprise the step of:
testing a sample of liquid from the first tank and/or a sample of condensed liquid from the second tank for the presence of biological particles.

Also, the first and second tank of said device can be in fluid communication and the method can comprise:
testing a mixture of said sample of liquid and sample of condensed liquid for the presence of biological particles.

When the collecting means of said device or the bio support filter of said device are equipped with one or more biosensor(s), said testing step can be carried out by contacting the sample(s) of liquid present within the collecting means the liquid leaking from the bio support filter respectively with said one or more biosensor(s). Moreover, also the one or more air inlets of said device can be equipped with one or more biosensor(s) and said testing can further comprise contacting the inlet air with said one or more biosensor(s), preferably wherein said one or more biosensor(s) comprise a bioreceptor configured to specifically interact with one or more biological particle(s). Examples of bioreceptor are enzymes, cells, aptamers, deoxyribonucleic acid (DNA), antibodies or a mixture thereof.

The biosensor(s) present at the air inlets of the device, can detect and/or monitor the presence of biological particles (e.g. bacteria or viruses) in the air, while the biosensor(s) contacting the liquid within the device, e.g. within the collecting means of the device, can detect and monitor the effective capture and destruction or deactivation.

Biosensors suitable for the method of the present invention are as generally known in the art, particularly from Essays Biochem. 2016 Jun. 30; 60(1): 1-8, published online 2016 Jun. 30. doi: 10.1042/EBC20150001 and Chen S, Cheng Y F. Biosensors for bacterial detection. Int J Biosen Bioelectron. 2017; 2(6):197-199. DOI: 10.15406/ijbsbe.2017.02.00048. Said biosensors can be either single shot tools to be replaced after one use or long-monitoring tools. Biosensor particularly suitable for the present invention are those able to specifically detect biological particles such as those herein defined, especially bacteria (Pseudomonas Aeruginosa, Clostridium Perfringens, Salmonella, etc.) and viruses (Sars-CoV-2, H1N1, etc.).

When the device is equipped with one or more biosensors, the method can further comprise the step of signaling the presence of one or more biological particles, wherein said signaling is carried out by providing the biosensor(s) with a transducer configured to produce a detectable signal, preferably wherein said detectable signal is an optical or electrical signal, more preferably wherein said detectable signal is proportional to the amount of biological particle-bioreceptor interaction.

Optionally, said signaling can further comprise displaying the result on a dedicated dashboard software and/or transmitting the result to a cloud-based server using an access point affixed to the sensor and/or analyzing the result using a software optionally providing an output of the analysis.

According to a preferred embodiment, said signaling step comprises the switching on of one or more lights on the surface or display of bioreactor device.

Moreover, the present invention also refers to the use of a device as defined in any one of embodiments disclosed herein, for detecting and/or monitoring the presence of biological particles in the air by testing the liquid of one or more collecting means, and optionally also the inlet air, of a device as defined herein, wherein said biological particles are preferably selected among the group consisting of bacterial cells and spores, viruses, pollen, fungi, algae, detritus, allergens, protozoa, parasites, and/or cell fragments including nucleic acids, proteins and toxins, and wherein said viruses are preferably coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus.

According to any of the embodiments of the invention, the biomass additive of the device is a nonpathogenic, non-genetically modified micro-organisms consortium additive.

According to an embodiment, the consortium can comprise a stable variable mix of aerobic and/or anaerobic species, fungi and yeast, both from natural sources and from specific selected strains preferably selected among the group comprising, but not limited to: Bacillus specie (spp), Lactobacilli spp, Actinobacteria spp, Proteobacteria spp, Cianobacteria spp, Deinococcus spp, Clorobacteriacee, Spirochaetalea and/or mixtures thereof.

According to an embodiment the biomass additive can further comprise one or more co-formulants preferably selected among the group comprising, but not limited to: quartz, anthracites, carbonates, silicates, metal ions and salts, protein extracts, enzymes, amino acids, natural extracts in general and mixtures thereof.

According to any of the embodiments of the invention, the bio support filter of the device can be shaped to include an air passageway in the form, for example, but not limited to, of one or more concentric channels, one or more vertical channels, or a corkscrew.

According to any of the embodiments of the invention, the device further comprises an electronic control unit, the electronic control unit comprising a communication module for IOT remote control, and/or an air quality monitoring system, preferably wherein the air quality monitoring system includes one or more sensors for detecting an air quality parameter, said one or more sensors preferably selected from a VOC sensor, Particulate Matter sensors, carbon monoxide sensor, CO2, NO2, SO2, formaldehyde, radon, radioactivity (and more) a temperature sensor, a humidity sensor, a odorous gas sensor, a gas sensor, and a combination thereof. Air Quality sensors are also combined to water quality sensors placed inside the air purification devices such as conductivity, turbidity, dissolved oxygen, dissolved CO2 (and more). More sensors can provide information on components system failures, geo-localization, operational time tracking.

The data collected from the sensors are sent to the cloud and the interrelation of the parameters can be analyzed and filtered by specific algorithms, machine learning and AI consulted through a IoT web hosted dashboard.

According to any of the embodiments of the invention, the air quality monitoring system also comprises an access point for transmitting data associated with the air quality parameter to a cloud-based server for further analysis via a dedicated software.

According to any of the embodiments of the invention, the device further comprises a vent to generate air flow throughout the bio support filter to oxygenate microbial additive and capture larger particles in addition to the fine ones already attracted by electrical molecular charge attraction.

According to any of the embodiments of the invention, the pipe system of the device includes a pump and a one or more pipes attached to the pump, wherein the pump is configured to withdraw the liquid from the tank and to distribute the liquid in the bio support filter via the one or more pipes.

According to any of the embodiments of the invention, the bio support filter of the device includes a plate onto which the liquid is collected from the water tank, discharged from the pipes, wherein liquid flows into the bio support filter from the plate via holes within the plate and back down to the tank.

According to any of the embodiments of the invention, the plate includes a protective grid on top of which the biomass additive is disposed.

According to any of the embodiments of the invention, the device further comprises an outlet tap for releasing the liquid from the tank.

According to any of the embodiments of the invention, the device further comprises an electro valve for automatic liquid filling and/or a tank support base for providing ground support to the tank, and/or a liquid level sensor for assessing the level of the liquid within the tank and/or a top cover for covering internal water sensitive components of the device.

According to any of the embodiments of the invention, the device is configured to purify air from contaminants having a particle diameter smaller than 0.5 microns by grounding the suspended particles by “electrical charge attraction”.

Even if is already known in the art that the device described in the International Patent Application No PCT/US2019/016440 can be used as air purification system, it has never been shown that it can also be effective in digesting and/or destroying biological particles or bioaerosols such as viruses.

Therefore, the present invention also relates to the use of the device or of the kit of parts according to any of the embodiment of the present invention, or according to any of the embodiments disclosed in the International Patent Application No PCT/US2019/016440, for purifying the air from biological particles, preferably from one or more viruses, wherein said viruses are preferably coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus, more preferably SARS-CoV-2.

In particular, the invention relates to the use of a device comprising:
collecting means configured to receive a liquid therein;
a bio support filter configured to accommodate a biomass additive and comprising an air passageway, the biomass additive configured to digest contaminants within air passing through the air passageway by bio-oxidation;
a pipe system configured to transport the liquid from the collecting means to the bio support filter, thereby providing moisture sufficient for the biomass additive to digest the contaminants;
one or more air inlets for allowing contaminated air to enter into the device; and one or more air outlets for discharging purified air;
for purifying the air from biological particles,
   wherein said biological particles are preferably selected among the group consisting of bacterial cells and spores, viruses, pollen, fungi, algae, detritus, allergens, protozoa, parasites, and/or cell fragments including nucleic acids, proteins and toxins, and wherein said viruses are preferably coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus.

The invention also relates to the use of a kit of parts comprising a device which comprises:
collecting means configured to receive a liquid therein;
a bio support filter configured to accommodate a biomass additive and comprising an air passageway, the biomass additive configured to digest contaminants within air passing through the air passageway by bio-oxidation;
a pipe system configured to transport the liquid from the collecting means to the bio support filter, thereby providing moisture sufficient for the biomass additive to digest the contaminants;
one or more air inlets for allowing contaminated air to enter into the device; and one or more air outlets for discharging purified air;
   and a test, preferably an antigen test cassette, an immunochromatographic test cassette or lateral-flow cassette, more preferably an IgA and/or IgM and/or IgG test cassette, for purifying the air from biological particles wherein said biological particles are preferably selected among the group consisting of bacterial cells and spores, viruses, pollen, fungi, algae, detritus, allergens, protozoa, parasites, and/or cell fragments including nucleic acids, proteins and toxins, and wherein said viruses are preferably coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus, preferably wherein said test is to be performed on a sample of liquid of one or more collecting means of said device.

The invention also refers to the use of an antigen test cassette, preferably an immunochromatographic test cassette or lateral-flow cassette, more preferably an IgA and/or IgM and/or IgG test cassette, for detecting the presence of biological particles within the liquid of one or more collecting means (e.g. one or more tank) of a device as defined therein, or as defined according to any of the embodiment disclosed the International Patent Application No PCT/US2019/016440, wherein said biological particles are preferably selected among the group consisting of bacterial cells and spores, viruses, pollen, fungi, algae, detritus, allergens, protozoa, parasites, and/or cell fragments including nucleic acids, proteins and toxins, and wherein said viruses are preferably coronaviruses, beta-coronaviruses, SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza virus 1, 2, 3, or 4 and/or Metapneumovirus.

According to a preferred embodiment, said test cassette is a SARS-CoV-2 IgA and/or IgG and/or IgM test cassette.

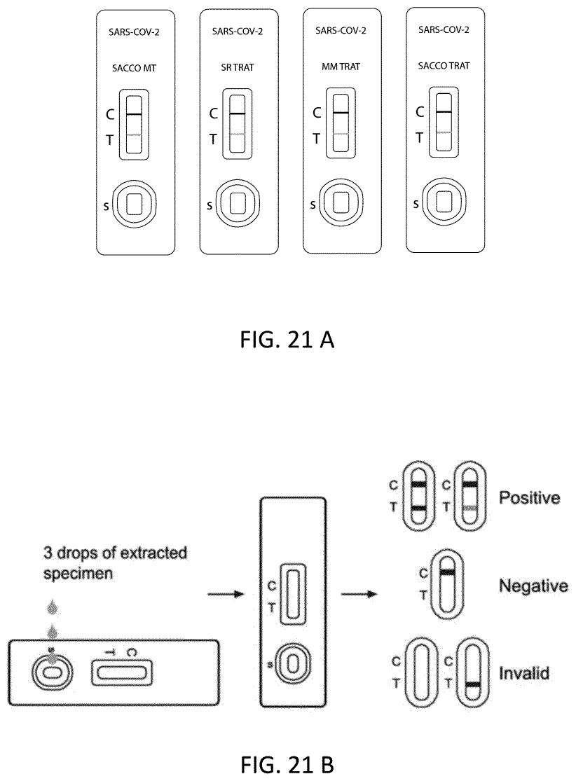

The SARS-CoV-2 IgA and/or IgG and/or IgM test cassette is a rapid immunochromatographic test cassette for the qualitative detection of SARS-CoV-2 antigens. The SARS-CoV-2 antibody coated region of the test line in contact with the sample reacts with the test SARS-CoV-2 antibody coated particles. The mixture then migrates upward on the membrane by capillary action and reacts with the SARS-CoV-2 antibody in the test line region. If the sample contains SARS-CoV-2 antigens, a colored line will appear in the test line region as a result of the reaction; it is important to specify that the first reaction visible on the test is the control line C which must always be visible. If the specimen does not contain antigens for SARS-CoV-2, no colored line will appear in the T test line region, only the one at position C indicating a negative result. The results of this test (FIGS. 21A-21B) refer to the detection of SARS-CoV-2 antigens in the sample of liquid collected from the tank of the device. As already explained above, a positive result can be also confirmed by subjecting the same sample to RT-PCR analysis.

According to an embodiment, the invention also refers to the use an antigen test cassette, preferably a SARS-CoV-2 IgA and/or IgG and/or IgM test cassette, for detecting the presence of the virus within the liquid of the tank of a device as herein defined, wherein said use comprises the following steps:
collect a sample of liquid from the tank of the device herein disclosed, for example, by means of a pipette;
Remove the pipette from tank and insert two or three drops (about 100 μL) into the well (S) of the cassette (FIG. 21B); and
Wait, preferably about 15 minutes, for the chromatographic reaction by capillarity to occur.

Having thus described several embodiments for practicing the invention, its advantages and objectives can be easily understood. Variations from the description above may and can be made by one skilled in the art without departing from the scope of the invention. Accordingly, this invention is not to be limited by the embodiments as described, which are given by way of example only and not by way of limitation.

### Examples

### Technology Testing History on Airborne Contaminants at Saronno Hospital

The study objective was to implement the first application of the device of the invention, marketed under the name Aircel bioreactor, in Europe, with the aim of achieving the Italian Health and Environment Authority validation in order to proceed with further application and also to verify the system efficiency in a highly frequented hospital environment. This study involved U-Earth, as the system provider, ASL (Health Authority) as hospital counterpart, and ARPA Lombardia (Environment Authority) for monitoring activities and data validation. All participants in the study were bound by secrecy.

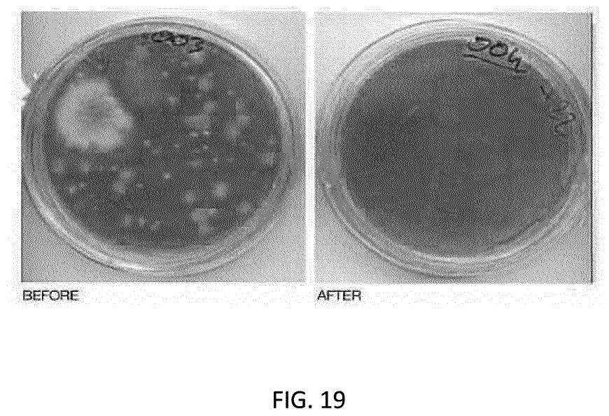

The study outline included the installation of one Aircel 600 and four Aircel 85 into a highly frequented hospital area of 1000 sqm with a turnover of about 1300 people per day. The units were placed in visiting rooms, the central booking office, and a waiting area for 100 people (FIG. 18). To verify the effectiveness of the system, monitoring activity on indoor air quality was performed for a one-month duration.

The monitoring activity was also performed on processed water quality to evaluate the fate of contaminants captured. The trial was carried out in full operative time, with no sealing of the indoor environment (door and windows open or closed-depending only on staff/patients' needs). Containment concerns and sampling methodology involved investigation of the medium and the contaminants along with the used methodology shown in the following—Table I (a).

TABLE I
(a) Showing medium investigated, contaminants and methodology

| Medium | | |
|---|---|---|
| Investigated | Contaminant | Methodology |
| Air | Bacteria and viruses | SAS (Surface Air Surface) and |
| | | analysis of Petri plates |
| Air | Particulate | AEROTRAK Particle Counter |
| | (0.3-0.5; 0.5-1.0; 2; 3-5) | |
| Water | Bacteria and viruses | Microbiological analysis |
| Water | Chemical contaminants | Standard Chemical analysis |
| | (metals, TOC, conductivity) | |

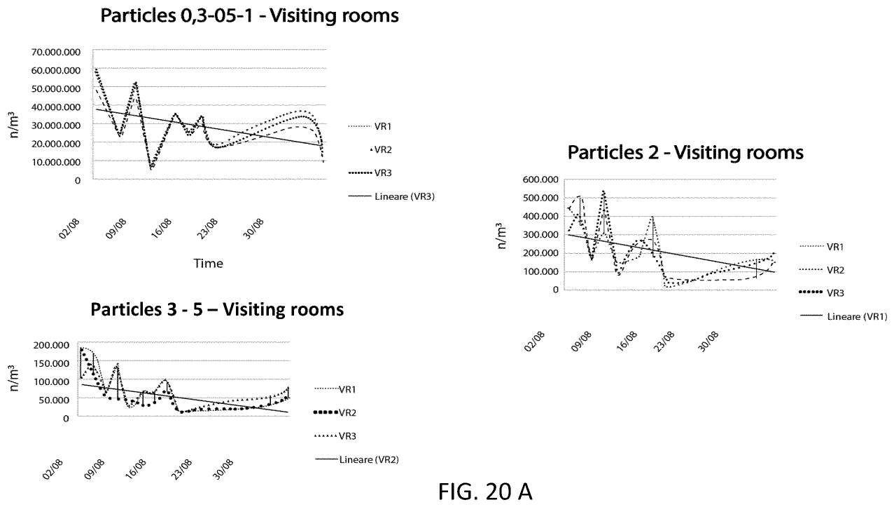

For contaminants sampling and analysis, the AEROTRAK™ Portable Airborne Particle Counter (ISO 21501-4:2007), was used for cleanroom particles classification following ISO 14644-1:1999 (0.3; 0.5; 1; 2; 3; 5 microns). The other instrument that was used was the SAS Super IAQ Surface Air System, that is conveying a known volume of air during a fixed period of time on Petri Plates filled with Standard Plate Count Agar (PCA) (FIG. 19). Samples were then cultivated, and colony formed were counted after characteristic intervals.

In terms of bacteria and viruses count, the results showed approximately a 90% reduction in bacteria and viruses count in the waiting area, above a 95% reduction in the central booking office, and an average reduction of 90% in the visiting room.

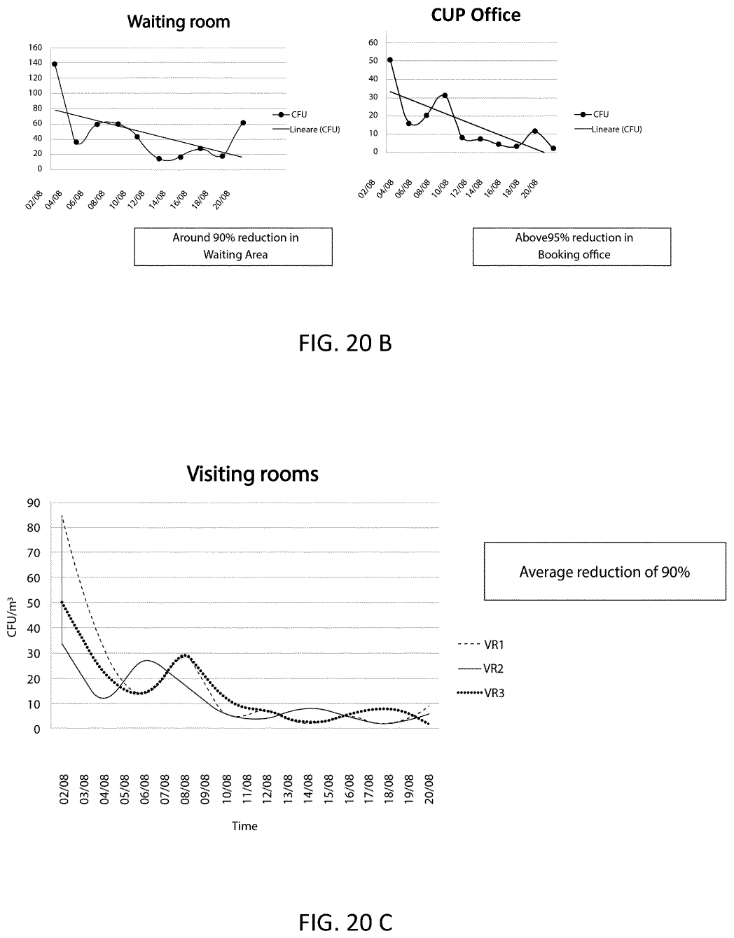

The particles count results show the different classes for particle size which were checked, obtaining remarkable reductions in the number of particles per cubic meter as shown in the following table (Table Ib) and graphs of FIGS. 20 A-20C.

TABLE I
(b) particles size, monitoring area, average
and maximum reduction per cubic meter

| | | AVG | Max |
|---|---|---|---|
| Particles size | Monitoring area | reduction | reduction |
| 0.3-0.5; 0.5-1.0 | Visiting Rooms | 51% | 86% |
| microns | | | |
| | Booking Office | 37% | 83% |
| | Walking Area | 35% | 85% |
| 2 | Visiting Rooms | 49% | 89% |
| microns | | | |
| | Booking Office | 33% | 74% |
| | Walking Area | 40% | 80% |
| 3-5 | Visiting Rooms | 60% | 90% |
| microns | | | |
| | Booking Office | 47% | 70% |
| | Walking Area | 43% | 63% |

It is important to note that pathogenic bacteria count was also checked in the processed water after 5 months of system activity, comparing results with tap water supplied in the hospital and findings were as follows—Staphylococcus and Pseudomonas were found in a single sample and subsequently were never found again. This proves that the bacteria were captured by the Aircel system and digested by the biomass additive (U-Ox) contained therein, as also interpreted and agreed by the Health and Environment Authority. Legionella, Enterovirus, Escherichia Coli, Enterobacteria, Enterococcus, and Salmonella could not be found. The contaminants derived from particulate desegregation have been traced in AIRcel processed water, increasing the concentration from reference tap water to one or in some cases even more that one orders of magnitude. Water quality parameters most affected by working conditions were identified in the following; conductivity, TOC, Fluorides, Chlorides, Ca, Mg, K, Cu, Fe, Mn, As.

Overall, the study proved the effectiveness of the system on Total Viable Count with a reduction of concentration above 90% and the reduction of Particulate Concentration depending on particle size (smaller particles decrease faster). It's also important to note that accurate equipment maintenance can improve system efficiency significantly; with increasing working time, a clean-up would have been required in order to keep performance at such a high level, since residual material from oxidation would limit the self-purification capacity of the system. An outlook for hospital/medical environment applications includes areas where formaldehyde is used, due to its being a major carcinogenic concern in the indoor environment. VOC (for example in a dental clinic, to reduce anesthetic gas concentration), and of course special attention to airborne bacteria. Results related to pre-COVID validation in Saronno Hospital on VOC, particulate and airborne bacteria are presented due to impossibility to test all contaminants during the COVID-19 crisis at hospital wards and in order to better understand the capture and destruction dynamics of the technology that occurred during the SARS nCoV-2 testing in Milan hospitals during the crisis.

### Technology Testing for SARS-CoV-2 at Multimedica, San Raffaele and Sacco Hospital in Italy

The numerous previous field testing activities carried out in the past, have in fact demonstrated a remarkable ability to use AIRcels especially in the context of airborne pollution. The sampling procedures conducted by Lab Clodia and U-earth in 3 hospitals in Milan during the COVID-19 pandemic peak, aimed specifically at detecting traces of SARS-CoV-2 in the water recirculating inside the devices, to demonstrate the destruction of the captured virus on the following testing run. During this time air quality sampling was not possible due to the restricted access to COVID-19 areas and the high risk of contagion. However, water samples were extracted by the hospital staff and sent to Lab Clodia in Bolzano for both SARS-CoV-2 and generic beta coronavirus extraction. AIRcel effectiveness was also confirmed in this instance, allowing us first to detect the presence of, and subsequently to prove the destruction of beta coronavirus, in some of the devices placed inside hospitals.

### Materials and Methods

The detection systems of SARS-CoV-2 used are based upon conventional RT-PCR which involves radioactive isotope markers to detect genetic materials of the SARS nCoV-2 pathogen. It is based upon biomolecular assay and sensitive for mRNA detection. The target sequences have been identified and made public since December 2019, therefore the manufacturers of the detection kits were able to market products useful for identifying the target sequence responsible for the pandemic, in the early months of 2020.

The SARS-CoV-2 capture and destruction have previously proven themselves during the experimental activities that were being conducted on an AIRcel Air-purifiers based on both on-field positive testing on pathogenic bacteria, VOC, and fine Particulate Matter, and on a series of laboratory tests at the research center in Bolzano. In fact, in order to verify the treatment capacity of the AIRcel bioreactor, numerous tests were carried out with microbial strains, including pathogens, proving in practice that the concept of a “pure air zone” can be applied to hospital sites involved in the coronavirus emergency.

### The Multiple Real-Time PCR Kit

In many of the samples taken from the water recirculating inside the device, beta-coronaviruses were detected with the multiplex platform (XABT) Multiple Real-Time PCR Rotor Gene (Qiagen), a particular SARS-CoV-2 detection kit for detection of 2019-nCov, based on a multiplex platform capable of simultaneously detecting an extended group of beta coronaviruses. In fact, this kit consists of two distinct master mixes identified by tube A and tube B. The first is specific to the target SARS-CoV-2 gene ORF1ab+N, while the second contains the generic beta-coronavirus E gene. To prove its effectiveness, the kit was tested with extremely diversified types of samples: in addition to the classic buccal or oropharyngeal samples, fecal samples, and solute samples from AIRcel bioreactors were extracted.

### AIRcel Solute Testing

In order to test the solute from the AIRcels bioreactors, the QIAGEN's Pathogen extraction kit supplied by QIAGEN, (Hilden Germany) was used, in a total of 68 samples that were processed in three distinct test sessions between April and June 2020, using the Q6600 QIAGEN's Rotor-Gene thermal cycler. The detection system of the AIRcel air purifiers is thus mainly based upon reverse transcription-polymerase chain reaction (RT-PCR), which enables it to detect traces of SARS nCoV-2 virus.

Another session of experiments was conducted to test a new rapid diagnostic kit for the detection of SARS-CoV-2 antigen, on samples which already tested positive for the specific target when processed with the PCR-RT multiplex protocol by Xabt Beijing Applied Biological Technologies Co. Ltd.

Both positive and negative samples were then compared to verify the sensitivity of the rapid kit and its use since the CE IVD validation required its use for diagnostic purposes only. The results with the rapid kit (antigen) are in line with those obtained with PCR RT. Essentially the same quantity as foreseen by the protocol validated with nasopharyngeal swab was tested by directly entering the solute extracted from the AIRcel water tank into the test panel cassette of the chromatographic support used to perform the test, the results are shown in FIGS. 21A-21 B.

### Results and Discussion

The results presented in the following tables (Table II a, b, and c) show a marked presence of the target beta coronavirus E gene for 19 of the 68 samples while the target ORF1ab+N was detected in 7 samples.

At Sesto San Giovanni (Multimedica) Hospital, the units were placed in the COVID-19 dialysis and visiting rooms.

In San Raffaele Hospital the units were placed in the ER and in the COVID Intensive Care dedicated ward, for the most serious cases, equipped with all the proper ventilation requirements (contamination most likely occurred during the application of ventilators on intubated patients).

At Sacco Hospital, the test results show the detection of ORF1ab+N and/or E gene in 15 samples out of 40.

AIRcel bioreactors were also placed in other COVID-19 treated areas including San Giuseppe Hospital, wherein the units were placed in the obstetrician, ER, and canteen areas.

TABLE II
(a) Test results show in Multimedica Hospital the detection of ORF1ab + N and/or E gene in 4 samples

| | 30 Apr. 2020 | 29 May 2020 | 4 Jun. 2020 | Notes |
|---|---|---|---|---|
| MM1 | | | | |
| SARS CoV-2 | Detected | Digested | Not Detected | The water was |
| | | | | not changed b/w |
| | | | | the 2 testing |
| | | | | rounds |
| Beta coronavirus | Detected | Digested | Detected | The water was |
| E gene | | | | not changed b/w |
| | | | | the 2 testing |
| | | | | rounds |
| MM2 | | | | |
| SARS CoV-2 | Not Detected | Not Detected | Not Detected | — |
| Beta coronavirus | Detected | Digested | Not Detected | The water was |
| E gene | | | | not changed b/w |
| | | | | the 2 testing |
| | | | | rounds |

(b) Test results show in San Raffaele Hospital the detection of ORF1ab + N and/or E gene in all 6 samples

| | 30 Apr. 2020 | 29 May 2020 | Notes |
|---|---|---|---|
| SR1 | | | |
| SARS CoV-2 | Not Detected | Detected | — |
| Beta coronavirus | Not Detected | Detected | — |
| E gene | | | |
| SR2 | | | |
| SARS CoV-2 | Not Detected | Detected | — |
| Beta coronavirus | Detected | Digested | The water was not |
| E gene | | | changed b/w the 2 |
| | | | testing rounds |
| SR3 | | | |
| SARS CoV-2 | Not Detected | Not Detected | — |
| Beta coronavirus | Detected | Detected | — |
| E gene | | | |
| SR4 | | | |
| SARS CoV-2 | Not Detected | Not Detected | — |
| Beta coronavirus | Not Detected | Not Detected | — |
| E gene | | | |

(c) Test results show in Sacco Hospital the detection of ORF1ab + N and/or E gene in 15 samples out of 40

| | 4 Jun. 2020 | 17 Aug. 2020 | Notes |
|---|---|---|---|
| SR1 | | | |
| SARS CoV-2 | Not Detected | Not Detected | — |
| Beta coronavirus | Detected | Detected | — |
| E gene | | | |
| SR2 | | | |
| SARS CoV-2 | Not Detected | Not Detected | — |
| Beta coronavirus | Not Detected | Detected | — |
| E gene | | | |
| SR3 | | | |
| SARS CoV-2 | Not Detected | Detected | — |
| Beta coronavirus | Not Detected | Detected | — |
| E gene | | | |
| SR4 | | | |
| SARS CoV-2 | Detected | Digested | The water was not |
| | | | changed b/w the 2 |
| | | | testing rounds |
| Beta coronavirus | Detected | Digested | The water was not |
| E gene | | | changed b/w the 2 |
| | | | testing rounds |
| SR5 | | | |
| SARS CoV-2 | Not Detected | Detected | — |
| Beta coronavirus | Not Detected | Not Detected | — |
| E gene | | | |
| SR6 | | | |
| SARS CoV-2 | Not Detected | Not Detected | — |
| Beta coronavirus | Not Detected | Detected | — |
| E gene | | | |
| SR7 | | | |
| SARS CoV-2 | Not Detected | Detected | — |
| Beta coronavirus | Not Detected | Detected | — |
| E gene | | | |
| SR8 | | | |
| SARS CoV-2 | Not Detected | Not Detected | — |
| Beta coronavirus | Detected | Detected | — |
| E gene | | | |
| SR9 | | | |
| SARS CoV-2 | Not Detected | Not Detected | — |
| Beta coronavirus | Not Detected | Detected | — |
| E gene | | | |
| SR10 | | | |
| SARS CoV-2 | Not Detected | Not Detected | — |
| Beta coronavirus | Not Detected | Detected | — |
| E gene | | | |

### Further Testing on Samples: Efficacy of the Biomass Additive

The in-lab testing activity confirmed the detection of positive samples coming from the hospitals. To get the most out of the unique opportunity to deal with SARS-CoV-2 RNA, further experimental activity and related tests were conducted on the acquired samples. Twelve water samples of 100 ml each were selected and collected from hospital units that tested positive for both viral targets, and they were treated with 1 ml of biomass additive of the present invention (U-ox microbial additives, made of a stable variable mix of aerobic and anaerobic species, fungi and yeast, both from natural sources and from specific selected strains, mixed with co-formulants such as, but not limited to: quartz, anthracites, carbonates, silicates, metal ions and salts, protein extracts, enzymes, amino acids and natural extracts in general) on an equal volume of sample to test the short-term degradation capacity in vitro. In 5 out of 12 samples, traces of the viruses were no longer found after the overnight period.

### Ventilation and Particle Behavior

In terms of airborne pathogens and ventilation, the latest study in April 2020 showed evidence that SARS-CoV-2 widely spreads in the air, and that the air transmission distance might reach up to 4 meters in hospital wards (Guo Z., Wang Z., Zhang S., et al.: Aerosol and surface distribution of severe acute respiratory syndrome coronavirus 2 in hospital wards, Wuhan, China, 2020. Emerg. Infect. Dis. 2020; 26(7):1583-1591. DOI: 10.3201/eid2607.200885). Coincidingly, WHO recommends a ventilation rate of at least 288 m³/h per person, for the control of opportunistic airborne transmission in health care settings (WHO Natural ventilation for infection control in health-care settings. 2009. https://www.who.int/water_sanitation_health/publications/natural_ventilation/en Accessed Mar. 27, 2020). A natural or mechanical ventilation system is necessary to achieve such a high ventilation rate. Nonetheless, natural ventilation depends on weather conditions and building structures, making it difficult to achieve such a ventilation rate all the time. Notably, the existing ventilation system in these hospitals receiving and curing COVID-19 patients during this crucial pandemic period, usually provides a lower ventilation rate, below the recommended minimum ventilation rate. Even where the ventilation systems run at optimal rate there are still frequent cases of airborne bacteria and viruses causing hospital infections. To contain the spread of the virus and reduce transmission and infection rates, air purifiers can act as a supplementary measure to reduce the indoor air contamination within hospital premises where adequate ventilation is not available. Also, another previous study has proved that air purifiers can significantly reduce health-care workers' exposure to aerosols and droplets in dental clinics (Chen C., Zhao B., Cui W., et al.: The effectiveness of an air cleaner in controlling droplet/aerosol particle dispersion emitted from a patient's mouth in the indoor environment of dental clinics. J. R. Soc. Interface. 2010; 7(48):1105-1118. DOI: 10.1098/rsif.2009.0516).

However, most air purifiers that are capturing air pollutants by using ventilation seem not to be completely effective. Five experiments (UtrupL. J., Werner K. and Frey A. H.: Minimizing pathogenic bacteria, including spores, in indoor air. J. Environ. Health. 2003; 66(5):19-26, 29. PMID: 14679721) were conducted to assess how aerosolized bacteria and spores respond like particulate contaminants to the primary electrical forces in a room. Most of them are too small to respond to gravity and ventilation, thus remaining suspended in the air causing potential contagion. This concept is also key to better understand viruses' possible spreading dynamics.

The results indicate a system's ability to capture virus droplets and destroy them inside the reactor. This grants AIRcels full-fledged inclusion as a valid support for biomonitoring of the areas where they are installed. This is valid not only for the classic pollutants but also against the virus responsible for the current pandemic, especially when paired with the air quality monitoring system disclosed above, for VOC, odorous gases, PM1, PM2.5, and CO2 history tracking, in the cloud. Periodic control of the AIRcel “sentries”, installed in strategic positions, can in fact constitute valid support for activating preventive measures to confine the affected areas without leading to policies of total lockdown of the inhabited areas or of industrial, commercial, or health activities. The useful and practical applications of this air biomonitoring-capture-destruction system are linked to the developed technologies that allow the detection of microparticles through the processing of the data acquired continuously by the air quality monitoring system and methods herein disclosed and their use in the detection and signaling of RNA traces of the virus in the AIRcel recirculating water. Therefore, it has been shown that the virus detection method of the invention, provides early warning that quickly (within 24 hours) confirms the presence of the viral targets being detected.

### CONCLUSION

This study has demonstrated that the Aircel bioreactors are able to monitor, capture and digest SARS nCoV-2 virus and beta-coronaviruses. It's also important to note that it is possible to carry out this checking activity periodically, on a scheduled basis, for the placed AIRcels. The continuous monitoring activities can in fact provide useful data on the biological activity of bioreactors over time, to evaluate how the microbial community present in the devices interacts with the virus. In this study, AIRcel bioreactors have demonstrated an analytical approach to maintain air quality and quantify the presence of viral targets through efficient biomonitoring leading to capture and destruction of SARS nCoV-2 and beta-coronaviruses.

The use of AIRcels as an environmental monitoring tool, especially if combined with the rapid detection system of the SARS Cov2 antigen eventually supplied with the air purifier, provides valid support to the user, by giving the possibility of carrying out a preventive diagnosis not only on air quality but also of the actual presence of the coronavirus, which will then be eventually confirmed with the RT-PCR technique by sending the sample to a reference laboratory if needed. Detecting the presence of inactivated SARS-Cov-2 in the AIRcels water tanks, for example in a school, while lowering the viral charge suspended could also effectively inform on the possible presence of positive individuals, for example in selected classrooms, that require further testing.

1. A method for detecting and/or monitoring the presence of biological particles in the air, the method comprising the following steps:
providing a device comprising:
collecting means configured to receive a liquid therein;
a bio support filter configured to accommodate a biomass additive and comprising an air passageway, the biomass additive configured to digest contaminants within air passing through the air passageway by bio-oxidation;
a pipe system configured to transport the liquid from the collecting means to the bio support filter, thereby providing moisture sufficient for the biomass additive to digest the contaminants;
one or more air inlets for allowing contaminated air to enter into the device; and one or more air outlets for discharging purified air;
collecting a sample of liquid from the collecting means of said device; and
testing said sample of liquid for the presence of one or more biological particles.

2. The method according to claim 1, wherein the collecting means of said device comprise a first tank configured to receive therein liquid and a second tank configured to receive therein condensed liquid captured from the air and wherein the method comprises:
collecting a sample of liquid from the first tank and/or a sample of condensed liquid from the second tank; and
testing said sample of liquid and/or sample of condensed liquid for the presence of biological particles.

3. The method according to claim 2, wherein the first and second tank of said device are in fluid communication and wherein the method comprises:
collecting a mixture of said sample of liquid and sample of condensed liquid; and
testing said mixture for the presence of biological particles.

4. The method according to claim 1, wherein said testing is carried out by subjecting the sample of liquid to one or more tests and/or analysis and/or assays, preferably selected among the group consisting of: molecular tests, PCR, RT-PCR or RT-PCR multiplex tests, DNA/RNA sequencing, antigen tests, antibody tests, enzyme-linked immunosorbent assay (ELISA), chemiluminescent immunoassay (CIA), lateral flow assay, immunochromatographic assay, in particular immunochromatographic test cassette, lateral-flow test cassette and combination thereof, preferably immunochromatographic test cassette and/or RT-PCR multiplex assays.

5. The method according to claim 1, further comprising the step of
signaling the presence of one or more biological particles, preferably wherein said signaling is carried out by providing the device with an optical sensor being in communication with the test and configured to detect and discriminate the result of the test,
more preferably wherein said signaling further comprises displaying the result on a dedicated dashboard software and/or transmitting the result to a cloud-based server using an access point affixed to the sensor and/or analyzing the result using the software optionally providing an output of the analysis.

6. The method according to claim 1, wherein said biological particles are selected among the group consisting of: bacterial cells and spores, viruses, pollen, fungi, algae, detritus, allergens, protozoa, parasites, and/or cell fragments comprising nucleic acids, proteins and toxins, preferably viruses, more preferably viruses selected among the group consisting of coronaviruses, in particular beta-coronaviruses, more in particular SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza Virus 1, 2, 3, or 4 and/or Metapneumovirus, still more preferably SARS-CoV-2.

7. The method according to claim 1, wherein the biomass additive of the device is a nonpathogenic, non-genetically modified micro-organisms consortium additive comprising aerobic and anaerobic species, fungi and yeast, preferably selected among the group consisting of: Bacillus specie (spp), Lactobacilli spp, Actinobacteria spp, Proteobacteria spp, Cianobacteria spp, Deinococcus spp, Clorobacteriacee, Spirochaetalea and/or mixtures thereof, optionally in admixture with co-formulants preferably selected among the group consisting of: quartz, anthracites, carbonates, silicates, metal ions and salts, protein extracts, enzymes, amino acids, natural extracts and mixtures thereof.

8. (canceled)

9. A method for detecting and/or monitoring the presence of biological particles in the air, the method comprising the following steps:
providing a device comprising:
collecting means configured to receive a liquid therein;
a bio support filter configured to accommodate a biomass additive and comprising an air passageway, the biomass additive configured to digest contaminants within air passing through the air passageway by bio-oxidation;
a pipe system configured to transport the liquid from the collecting means to the bio support filter, thereby providing moisture sufficient for the biomass additive to digest the contaminants;
one or more air inlets for allowing contaminated air to enter into the device; and one or more air outlets for discharging purified air;
testing a sample of liquid from the collecting means of said device for the presence of one or more biological particles.

10. The method according to claim 9, wherein the collecting means of said device comprise a first tank configured to receive therein liquid and a second tank configured to receive therein condensed liquid captured from the air and wherein the method comprises:
testing a sample of liquid from the first tank and/or a sample of condensed liquid from the second tank for the presence of biological particles.

11. The method according to claim 10, wherein the first and second tank of said device are in fluid communication and wherein the method comprises:
testing a mixture of said sample of liquid and sample of condensed liquid for the presence of biological particles.

12. The method according to claim 9, wherein the collecting means of said device are equipped with one or more biosensor(s) and wherein said testing is carried out by contacting the sample(s) of liquid with said one or more biosensor(s).

13. The method according to claim 9, wherein the bio support filter of said device is equipped with one or more biosensor(s) and wherein said testing is carried out by contacting the liquid leaking from the bio support filter.

14. The method according to claim 12, wherein the one or more air inlets of said devices are equipped with one or more biosensor(s) and wherein said testing is further carried out by contacting the inlet air with said one or more biosensor(s).

15. The method according to claim 12 wherein said one or more biosensor(s) comprise a bioreceptor configured to specifically interact with one or more biological particle(s), preferably wherein the bioreceptor is selected among enzymes, cells, aptamers, deoxyribonucleic acid (DNA), antibodies or a mixture thereof.

16. The method according to claim 9, further comprising the step of:
signaling the presence of one or more biological particles, wherein said signaling is carried out by providing the biosensor(s) with a transducer configured to produce a detectable signal, preferably wherein said detectable signal is an optical or electrical signal, more preferably wherein said detectable signal is proportional to the amount of biological particle-bioreceptor interaction.

17. The method according to claim 16, wherein said signaling further comprises displaying the result on a dedicated dashboard software and/or transmitting the result to a cloud-based server using an access point affixed to the sensor and/or analyzing the result using the software optionally providing an output of the analysis.

18. The method according to claim 1, wherein said biological particles are selected among the group consisting of: bacterial cells and spores, viruses, pollen, fungi, algae, detritus, allergens, protozoa, parasites, and/or cell fragments comprising nucleic acids, proteins and toxins, preferably viruses, more preferably viruses selected among the group consisting of coronaviruses, in particular beta-coronaviruses, more in particular SARS-CoV-2; Influenza A virus, Influenza A virus subtype H1, Influenza A virus subtype H3; Influenza B virus; Respiratory syncytial virus type A or type B; Adenovirus; Enterovirus; Parainfluenza Virus 1, 2, 3, or 4 and/or Metapneumovirus, still more preferably SARS-CoV-2.

19. (canceled)
